(19) United States
(12) Patent Application Publication
(10) Pub. No.: US 2014/0149232 A1
(43) Pub. Date: May 29, 2014

(54) Systems and Methods for Efficiently Identifying the Most Desirable Buyer of Online Advertising Inventory

(71) Applicant: Zenovia Digital Exchange Corporation, Douglasville, GA (US)

(72) Inventor: Dwight Ringdahl, Douglasville, GA (US)

(73) Assignee: ZENOVIA DIGITAL EXCHANGE CORPORATION, Douglasville, GA (US)

(21) Appl. No.: 14/171,823

(22) Filed: Feb. 4, 2014

Related U.S. Application Data
(63) Continuation of application No. 14/139,383, filed on Dec. 23, 2013.

(51) Int. Cl. G06Q 30/02

(52) U.S. Cl. CPC G06Q 30/0275
USPC 705/14.71

(57) ABSTRACT

Systems and methods presented herein may facilitate the programmatic purchase of online advertising space. In particular, information contained within a request transmitted by a seller of online advertising space may be extracted and used to cross-reference a database containing historical information associated with past transactions involving the sale of online inventory. The historical information may be used to generate a prioritized list of potential purchasers of the inventory and determine a customized offer price to be transmitted to each potential purchaser. The potential purchasers may then be serially contacted until a purchaser of the online advertising space is found.

This is a continuation application of U.S. patent application Ser. No. 14/139,383, filed Dec. 23, 2013, which is expressly incorporated herein by reference.

### FIELD OF EMBODIMENTS

The embodiments relate generally to systems and methods for selling and purchasing internet advertising space, and, more specifically, to systems and methods for determining the most desirable buyer(s) of the internet advertising space.

### BACKGROUND

Real-time bidding (“RTB”) is a recent development in programmatically buying and selling online advertising space (“inventory”). Typically, buyers of the ad space may use a Demand Side Platform (“DSP”), such as a trading desk, while sellers of the ad space use a Supply Side Platform (“SSP”). These entities or platforms may interact with a third entity called an exchange. The exchange hosts an exchange server that supports RTB. In some instances, the exchange may also subsume the role of the SSP and/or DSP.

As an example, a webpage may contain a hard-coded tag that causes the SSP to sell ad space as the webpage loads. To sell the ad space, the SSP may alert the exchange of the user and/or webpage where the advertisement space is available. The exchange server supporting RTB then begins an auction with multiple DSPs and even other exchanges to determine which advertiser gets to serve the ad. The exchange server may communicate attributes of the user to the DSPs, which in turn determine whether the user has the desired attributes that the advertiser wants to target. Based on the perceived value of this user, each DSP places a bid on the ad impression (based on the advertisers associated with that DSP). The highest bidding advertiser may be determined by the exchange, at which point the advertisement may be delivered to the user.

It should be noted that any sale for the online advertising space must be completed in a relatively short period of time, e.g. approximately 150 ms. In a typical transaction, inventory may not be identified for sale until an end user or consumer directs his or her internet browser to a webpage. The transaction involving offering the inventory to one or more entities for purchase, the evaluation of that inventory, the ultimate sale of the inventory, as well as placement of an advertisement within the webpage for display at the user's computer, must all be completed by or shortly after the webpage loads at the user's browser. As a result, time restraints are a limiting factor in the sale of online advertising, making it difficult to ensure adequate liquidity. Additionally, it may be difficult to evaluate inventory sufficiently prior to placing it up for sale or submitting a bid for it in an RTB environment. As a result, parties with good intentions may unwittingly buy or sell “bad” inventory (inventory supplied by malicious/deceitful publishers or bots) within an RTB auction.

Accordingly, RTB systems and methods, and RTB exchanges in particular, could benefit from improved devices and techniques for facilitating the online sale of ad space, while increasing win rates, volume and liquidity for those entities participating in RTB auctions within the exchange.

### SUMMARY

In accordance with certain embodiments of the present disclosure, systems and methods for facilitating the sale of online advertising space.

In one aspect, systems and methods disclosed herein may facilitate the programmatic identification of a most desirable potential purchaser of online advertising space or inventory. In particular, the most desirably potential purchaser of the online advertising space may be identified using a database containing historical data pertaining to past transactions involving the sale of online inventory. A prioritized list of a plurality of potential buyers may be generated based, at least in part, on the historical data. The potential buyers may then be serially contacted regarding the purchase of the online advertising space until the most desirable willing buyer is identified.

In one aspect, a method disclosed herein may comprise: receiving a request from a sender, the request being associated with an advertising space located within content being delivered over the Internet to a consumer; extracting information from the request; cross-referencing a database based, at least in part, on the information, the database comprising data pertaining to past transactions involving the sale of online inventory; generating a prioritized list of one or more potential purchasers of the advertising space based, at least in part, on the data pertaining to the past transactions; transmitting a first ad request to a first recipient on the prioritized list, the first ad request being associated with the advertising space and comprising a first offer price; and if the first ad request is accepted by the first recipient, transmitting an acceptance message to the sender; or if the first ad request is rejected by the first recipient, transmitting a second ad request to a second recipient on the prioritized list, the second ad request being associated with the advertising space and comprising a second offer price.

In another aspect, a system described herein may comprise: a filtering component configured to receive a bid request associated with an advertising inventory being sold within a real-time auction; and a waterfall component configured to: generate a list of one or more potential purchasers of the advertising inventory; determine a recipient of an ad request associated with the advertising inventory, the recipient being the most desirable potential purchaser of the advertising inventory from the list; transmit an ad request to the recipient, the ad request comprising an offer price; if the ad request is not accepted by the recipient, remove the recipient from the list and repeat a portion of the aforementioned process; if the ad request is accepted by the recipient, generate a bid based, at least in part, on the accepted offer price; and transmit the bid to the real-time auction.

In a further aspect, a method disclosed herein may comprise: (a) receiving a bid request associated with online inventory being sold in a real-time auction; (b) in response to the bid request, accessing a database comprising information associated with past transactions; (c) identifying a potential buyer of the online inventory based, at least in part, on the information contained in the database; (d) determining an offer price based, at least in part, on the information contained in the database; (e) transmitting an ad request to the potential buyer, the ad request comprising the offer price; (f) if the ad request is not accepted: (f)(1) identifying a next potential buyer of the online inventory based, at least in part, on the information contained in the database; and (f)(2) repeating steps (d), (e), and (f)(1) until the respective ad request is accepted; and (g) if the ad request is accepted, transmitting a bid amount to the real-time auction.

Additional objects and advantages of the present disclosure will be set forth in part in the description which follows, and in part will be obvious from the description, or may be learned by practice of the disclosure. The objects and advantages of the disclosure will be realized and attained by means of the elements and combinations particularly pointed out in the appended claims.

It is to be understood that both the foregoing general description and the following detailed description are exemplary and explanatory only and are not restrictive of the embodiments, as claimed.

### BRIEF DESCRIPTION OF THE DRAWINGS

The accompanying drawings, which are incorporated in and constitute a part of this specification, illustrate several embodiments and together with the description, serve to explain the principles of the disclosure.

FIG. 1 depicts an exemplary embodiment of an environment for facilitating the sale of advertising space within an RTB exchange;

FIG. 2 depicts an exemplary embodiment of a computing system as described herein;

FIG. 3 depicts an exemplary embodiment of a server network as described herein;

FIG. 4 depicts an exemplary embodiment of a system as described herein;

FIG. 5 depicts some aspects of an exemplary embodiment of a method as described herein;

FIG. 6 depicts some aspects of an exemplary embodiment of a system as described herein;

FIG. 7 depicts some aspects of an exemplary embodiment of a system as described herein;

FIG. 8 depicts some aspects of an exemplary embodiment of a system as described herein;

FIG. 9 depicts some aspects of an exemplary embodiment of a method as described herein;

FIG. 10 depicts some aspects of an exemplary embodiment of a system as described herein;

FIG. 11 depicts some aspects of an exemplary embodiment of a method as described herein;

FIG. 12 depicts some aspects of an exemplary embodiment of a system as described herein;

FIG. 13 depicts some aspects of an exemplary embodiment of a system as described herein;

FIG. 14 depicts some aspects of an exemplary embodiment of a method as described herein;

### DESCRIPTION OF THE EMBODIMENTS

Reference will now be made in detail to the present exemplary embodiments, including examples illustrated in the accompanying drawings. Wherever possible, the same reference numbers will be used throughout the drawings to refer to the same or like parts.

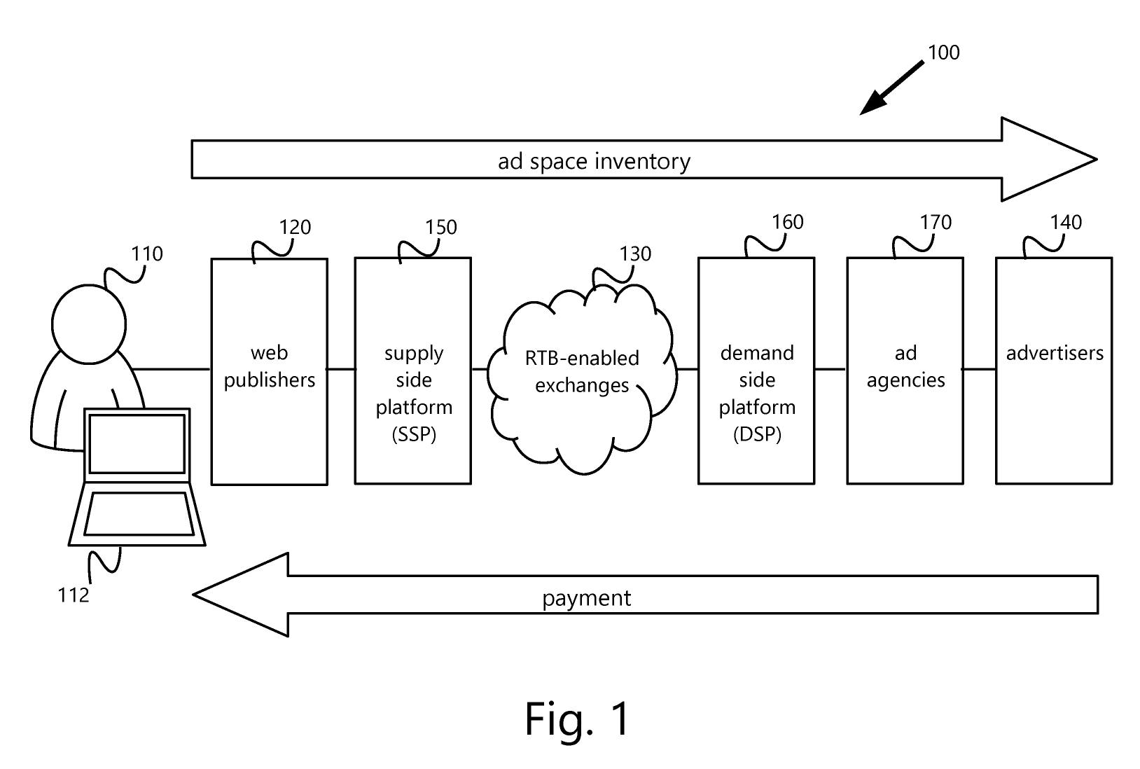

FIG. 1 depicts an exemplary environment 100 for facilitating the sale of advertising space, i.e., inventory, on a publisher's webpage to an advertiser. In particular, the flow of available inventory from the publisher (or supplier) to an advertiser, as well as the flow of compensation from the advertiser back to the publisher/supplier is generally depicted. In one aspect, environment 100 can comprise a consumer 110, a publisher of advertising space 120, an RTB-enabled exchange 130, and one or more advertisers 140.

In particular, when consumer 110, using a personal computing device 112 such as a desktop computer, laptop, tablet, or cell phone navigates to or “visits” the publisher's webpage, publisher 120 may wish to derive revenue from the consumer's visit by selling advertising space (or inventory) located on the publisher's webpage. In such an instance, an advertisement request (“ad request”) may be generated by publisher 120 and can be transmitted, directly or indirectly, to RTB exchange 130 for selling of the inventory to an advertiser.

In one aspect, when consumer 110 navigates to the publisher's webpage, information pertaining to consumer 110 may be transmitted to the publisher. For example, information collected by consumer 110's web browser (“cookies”) may be transmitted to publisher. Such information may include the consumer's web browsing history, the frequency with which the consumer visits particular webpages or types of webpages, and/or the consumer's online purchase history. Of course, these examples are only exemplary and other suitable information may also be collected and/or transmitted by the consumer's browser. In another embodiment, the consumer's computing device may transmit information indicative of consumer 110's geographic location, IP address, or other information. In a further embodiment, consumer 110 may have created an account at publisher 120's webpage during a previous visit to the webpage, and consumer 110 may have provided publisher with information in conjunction with creating that account. In such an instance, the information provided during creation of the account may also be recalled by publisher 120 when consumer 110 navigates to the publisher's webpage. In another embodiment, information collected by the consumer's internet service provider may be transmitted to publisher 120. In addition to the aforementioned information, publisher 120 may also possess information pertaining to consumer 110 that was collected during a previous interaction with consumer 110 and/or purchased from a third party data collector.

Upon receipt of any or all such information, publisher 120 may generate an ad request for transmission to RTB exchange 130. The ad request may contain all or any portion of the information collected from consumer 110, consumer 110's web browser, consumer 110's computing device, consumer 110's internet service provider, and/or a third party data collector. In one aspect, the ad request may further contain information pertaining to publisher 120. For example, the ad request may contain information indicative of the publisher's IP address, how many visits the publisher's webpage receives in a period of time, information indicative of the content of the webpage, and how many advertisements are located on the webpage. Again, these examples are only exemplary and other suitable information may also be included in the ad request. As discussed further herein, the information contained within the ad request will be generally referred to as “transaction information.”

The ad request containing the transaction information can then be transmitted to RTB exchange 130. In one embodiment, the ad request may be transmitted in the form of a recognized or predetermined protocol or sequence such that one or more recipients of the ad request can make use of the transaction information. RTB exchange 130 may also operate according to an agreed upon standard that all parties privy to exchange 130 have adopted. The ad request may also be transmitted in the form of a request for purchase of the associated advertising inventory at a predetermined price and/or an invitation to participate in an auction for the associated advertising inventory.

In another aspect, rather than publisher 120 transmitting the ad request directly to RTB exchange 130, the ad request may first be transmitted to an inventory aggregator 150 commonly referred to as a supply side platform (“SSP”). SSP 150 may, for example, aggregate advertising space inventory from a plurality of publishers and transmit a portion or all of any received ad requests to RTB exchange 130. In many instances, SSPs can promise a publisher a higher sale price on their inventory than the publisher could garner on its own because individual publishers with a small volume of inventory have a difficult time attracting advertisers' attention. By aggregating inventory from many such webpages, and thereby increasing inventory volume available for purchase, an SSP is able to attract these same advertisers' business.

Regardless of whether the ad request is transmitted by publisher 120 or SSP 150, the ad request may eventually be received by RTB exchange 130 where the associated advertising space inventory is sold in an auction environment to participating buyers. In one embodiment, prior to the inventory being sold at auction, exchange 130 may generate one or more bid requests, and transmit the bid requests to respective, participating advertisers, DSPs, or others potentially interested in purchasing the inventory. In one aspect, the bid request may be substantially similar to the ad requests described above, and may comprise all or a portion of the transaction information contained within the ad request.

In another aspect, any advertiser, DSP, or other potential purchaser of the inventory in receipt of the bid request may review the request and associated transaction information, and submit bids for purchasing the advertising space to be viewed by consumer 110 at publisher 120's webpage. For example, once the bid request and transaction information has been transmitted to participating advertisers or DSPs, a determination regarding how much to bid for particular inventory in view of a particular consumer/webpage can be handled on a case-by-case basis or according to predetermined algorithms constructed by each advertiser/DSP. If advertiser 140 is in the business of selling products known to be purchased by consumer 110, advertiser 140 may submit relatively higher bids for advertising space viewable by consumer 110 as compared to bids submitted for advertising space viewable by a consumer who has no history of purchasing the advertiser's goods. In another embodiment, advertiser 140 may have determined that consumers visiting a first webpage are more likely to buy the advertiser's products than consumers visiting a second webpage. In such an instance, advertiser 140 may submit higher bids on inventory associated with the first webpage than inventory associated with the second webpage. In one embodiment, advertiser 140 may have algorithms for weighting one or more data items from the transaction information according to a predetermined scale developed to identify consumers most likely to be interested in the advertiser's product(s). In such an embodiment, transaction information associated with consumers or webpages that match one or more profiles developed by advertiser 140 may trigger a bid on behalf of the advertiser for the advertising space associated with that transaction information or trigger a bid at a predetermined amount. Depending on an advertiser's evaluation of the transaction information associated with a particular consumer or publisher, the bid for the advertising space may vary.

In one embodiment, an auction for particular advertising space may remain open to the submission of bids from one or more advertisers for a predetermined amount of time. For example, an auction may remain open to the submission of bids for 100 milliseconds or some other amount of time shorter or longer than 100 milliseconds.

After the auction has closed, a winning bidder may be determined. The price the winning bidder pays for the adverting space may depend, at least in part, on the amount the winning bidder and/or other bidders bid at the auction. In one embodiment, a modified Vickrey auction may be conducted in which the winning bidder pays the price bid by a second place bidder. In other embodiments, a Vickrey auction, a sealed first-price auction, a Dutch auction, an English auction, or any other suitable auction style can be used.

In other embodiments of environment 100, rather than advertisers 140 directly submitting bids at RTB exchange 130, bids may be placed at exchange 130 by a marketing aggregator 160 commonly referred to as a demand side platform (“DSP”). DSP 160 may, for example, aggregate advertising demand from one or more advertisers 140 and facilitate the purchase of advertising space on those advertisers'behalf. In many instances, DSPs that rely on their own internal information caches and filtering processes can promise a higher return on investment for advertisers by targeting consumers and webpages more likely to result in click-throughs or sales for the advertiser. In other embodiments, both advertisers 140 and DSPs 160 may submit bids at exchange 130.

In a further aspect, rather than handling the creative efforts involved in generating internet advertising of various formats and suitable for display on one or more computing devices, advertisers delegate this function to an advertising agency 170. Advertising agency 170 may then, in some instances, stand between advertiser 140 and DSP 160 in a transaction involving the sale of advertising inventory by a publisher and the publication of an advertisement on a webpage.

In another aspect, in conjunction with placing a bid within exchange 130, advertiser 140 or DSP 160 may also transmit a link identifying the location of an advertisement for display at the publisher's webpage. Thus, in the event that the bid is sufficient to win the auction, the link to the advertisement has already been transmitted to exchange 130. Exchange 130 may then transmit the link to the winning advertisement to the SSP or publisher from whom the ad request was received. And, in a further aspect, the link is eventually provided to the webpage and displayed at the computing device of consumer 110 when the webpage loads. In one embodiment, the link to the advertisement may comprise identifying information, including a location of the advertisement and an advertisement identification number. For example, identifying information may contain information regarding a database in which the advertisement is contained and an identification number unique to the advertisement within the database. The database can be any database within or outside environment 100, and may be maintained locally by a party to the transaction or maintained in the cloud. In this manner, when the link is eventually provided to the webpage being visited by consumer 110, the appropriate advertisement can be located and displayed to the consumer.

In alternative embodiments, an advertisement to display at the webpage may be predetermined. For example, an advertiser 140 or DSP 160 may elect to display a particular advertisement every time it wins an auction within exchange 130. In another embodiment, an advertiser 140 or DSP 160 may create multiple identities for bidding within exchange 130 and which advertisement is displayed at the webpage depends, at least in part, on which of the advertiser's identities won the auction. Of course, other suitable methods for determining an advertisement for display at the advertising space are possible and should be obvious in light of this disclosure.

Returning to the auction process, after a winning bid has been selected, exchange 130 may generate and transmit a confirmation message to the winning bidder. Where a DSP placed the bid within exchange 130, the confirmation message may first be received by the DSP and the DSP can then either forward the confirmation message to the advertiser/ad agency or generate a new confirmation message and transmit it to the advertiser/ad agency.

Payment for the placement of the advertisement at the publisher's webpage can then be handled. In one aspect, and as depicted in FIG. 1, when exchange 130 transmits the confirmation message to DSP 160, a financial account maintained by the DSP may be automatically debited for the appropriate amount. Alternatively, payment to exchange 130 for placement of the advertisement can be scheduled for some time in the future. In further embodiments, the DSP may have prepaid some amount to exchange 130 to be placed towards winning bids. In such an embodiment, upon a determination that the DSP has won the auction, the prepaid amount will be debited to reflect the purchase. Other suitable methods for facilitating payment to exchange 130 by DSP 160 are also possible and the examples provided herein are only exemplary.

Likewise, the DSP may receive compensation for its role in placing the advertisement from ad agency 170 who, in turn, receives its compensation from advertiser 140. The transactions between the DSP and ad agency, and the ad agency and the advertiser may or may not be substantially similar to the transaction described above between exchange 130 and DSP 160.

On the supply side of the transaction, SSP 150 may receive compensation for its role in placing the advertisement from exchange 130, and publisher 120 may receive its compensation for selling the advertising space from SSP 150. Again, the transactions between the exchange and the SSP and between the SSP and the publisher may or may not be substantially similar to the transaction described above between exchange 130 and DSP 160.

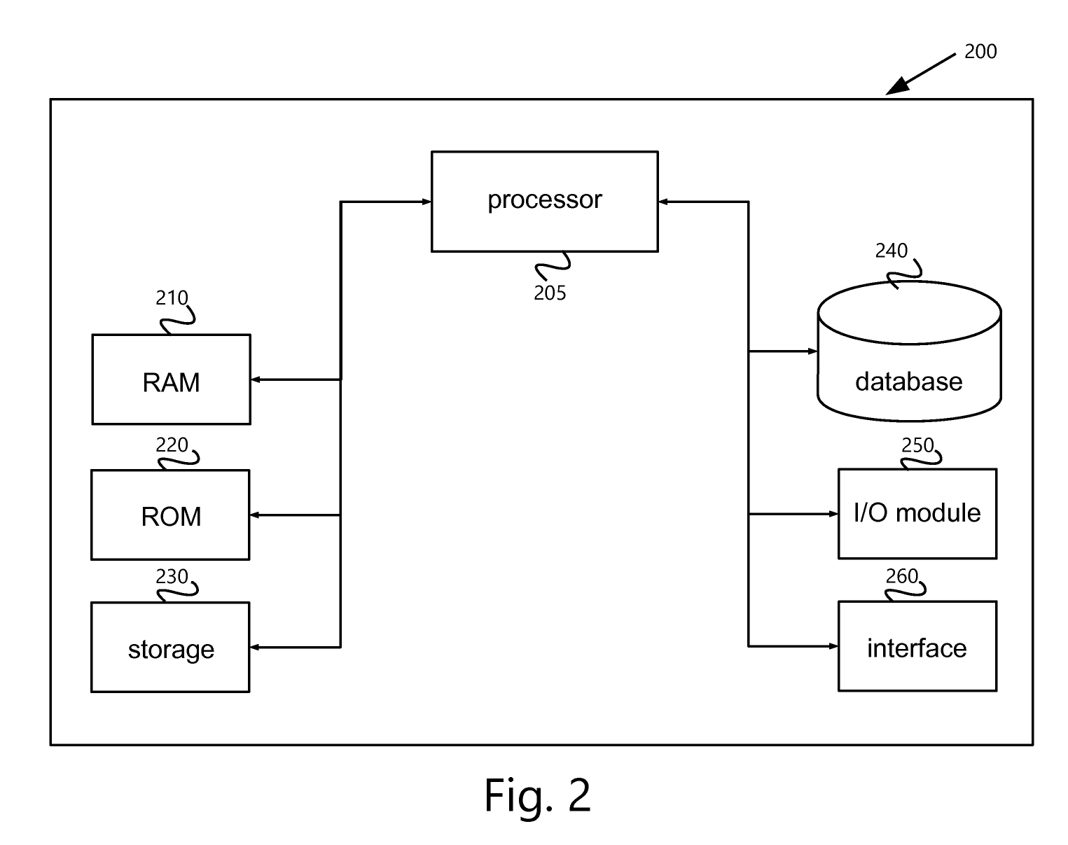

FIG. 2 depicts an exemplary processor-based computing system 200 representative of the type of computing system that may be present in or used in conjunction with any one or more of consumer 110's computing device, publisher 120, exchange 130, advertiser 140, SSP 150, DSP 160, and ad agency 170. In one embodiment, the features of any one or more of publisher 120, SSP 150, DSP 160, and ad agency 170 may be subsumed by exchange 130. Likewise, the features of publisher 120 and SSP 150 may be subsumed into one entity and/or the features of DSP 160, ad agency 170, and advertiser 140 may be subsumed into one entity. The computing system 200 is exemplary only and does not exclude the possibility of another processor- or controller-based system being used in or with one of the aforementioned components.

In one aspect, system 200 may include one or more hardware and/or software components configured to execute software programs, such as software for storing, processing, and analyzing data. For example, system 200 may include one or more hardware components such as, for example, processor 205, a random access memory (RAM) module 210, a read-only memory (ROM) module 220, a storage system 230, a database 240, one or more input/output (I/O) modules 250, and an interface module 260. Alternatively and/or additionally, system 200 may include one or more software components such as, for example, a computer-readable medium including computer-executable instructions for performing methods consistent with certain disclosed embodiments. It is contemplated that one or more of the hardware components listed above may be implemented using software. For example, storage 230 may include a software partition associated with one or more other hardware components of system 200. System 200 may include additional, fewer, and/or different components than those listed above. It is understood that the components listed above are exemplary only and not intended to be limiting.

Processor 205 may include one or more processors, each configured to execute instructions and process data to perform one or more functions associated with system 200. The term “processor,” as generally used herein, refers to any logic processing unit, such as one or more central processing units (CPUs), digital signal processors (DSPs), application specific integrated circuits (ASICs), field programmable gate arrays (FPGAs), and similar devices. As illustrated in FIG. 2, processor 205 may be communicatively coupled to RAM 210, ROM 220, storage 230, database 240, I/O module 250, and interface module 260. Processor 205 may be configured to execute sequences of computer program instructions to perform various processes, which will be described in detail below. The computer program instructions may be loaded into RAM for execution by processor 205.

RAM 210 and ROM 220 may each include one or more devices for storing information associated with an operation of system 200 and/or processor 205. For example, ROM 220 may include a memory device configured to access and store information associated with system 200, including information for identifying, initializing, and monitoring the operation of one or more components and subsystems of system 200. RAM 210 may include a memory device for storing data associated with one or more operations of processor 205. For example, ROM 220 may load instructions into RAM 210 for execution by processor 205.

Storage 230 may include any type of storage device configured to store information that processor 205 may need to perform processes consistent with the disclosed embodiments.

Database 240 may include one or more software and/or hardware components that cooperate to store, organize, sort, filter, and/or arrange data used by system 200 and/or processor 205. For example, database 240 may include user-specific account information, predetermined menu/display options, and other user preferences. Alternatively, database 240 may store additional and/or different information. Database 240 may also contain a plurality of databases that are communicatively coupled to one another and/or processor 205, which may be one of a plurality of processors utilized by exchange 130.

I/O module 250 may include one or more components configured to communicate information with a user associated with system 200. For example, I/O module 250 may include a console with an integrated keyboard and mouse to allow a user to input parameters associated with system 200. I/O module 250 may also include a display including a graphical user interface (GUI) for outputting information on a monitor. I/O module 250 may also include peripheral devices such as, for example, a printer for printing information associated with system 200, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 260 may include one or more components configured to transmit and receive data via a communication network, such as the Internet, a local area network, a workstation peer-to-peer network, a direct link network, a wireless network, or any other suitable communication platform. For example, interface 260 may include one or more modulators, demodulators, multiplexers, demultiplexers, network communication devices, wireless devices, antennas, modems, and any other type of device configured to enable data communication via a communication network.

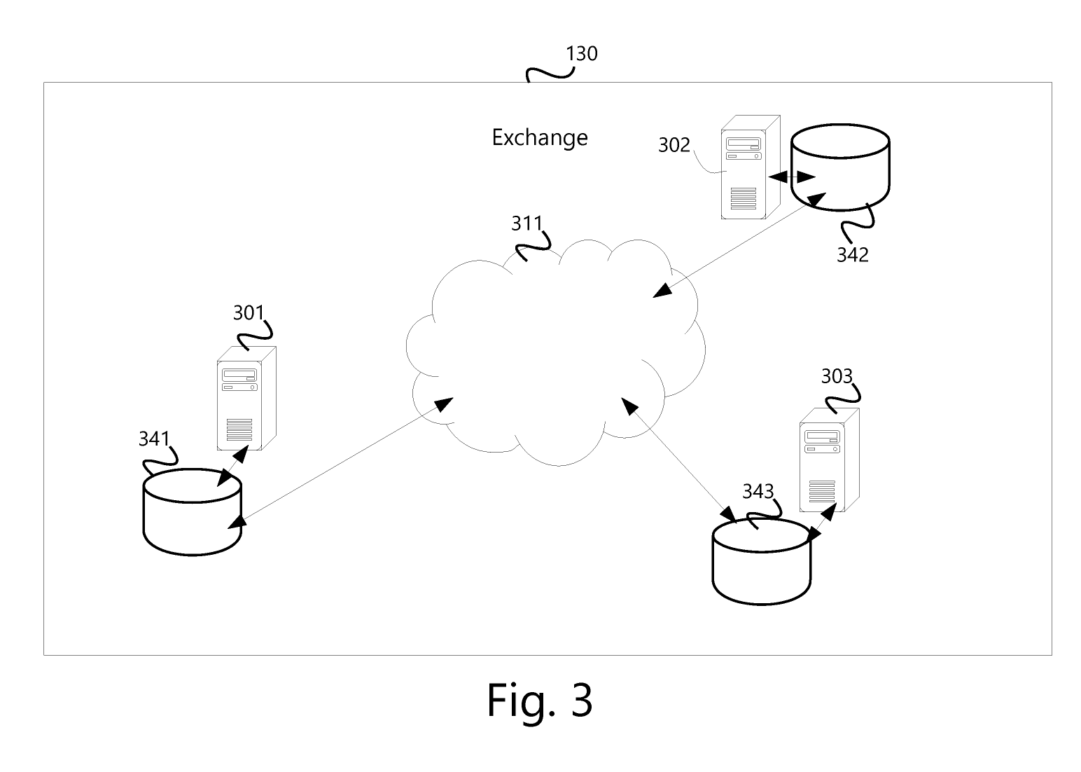

In another aspect, any one or more of consumer 110's computing device, publisher 120, exchange 130, advertiser 140, SSP 150, DSP 160, and ad agency 170 may comprise a distributed network of computing systems substantially similar the system depicted in FIG. 2. FIG. 3 presents an exemplary embodiment of an exchange 130 comprising multiple RTB servers 301, 302, and 303. These RTB servers may autonomously communicate with one another, as well as buyers and sellers of ad space. These buyers and sellers can be publishers, advertisers, SSPs, DSPs, ad agencies, trading desks, publishing desks, websites, or other entities, depending on the embodiment.

In the embodiment depicted in FIG. 3, each RTB server 301, 302, 303 may also be in communication with a respective user database 341, 342, 343 in one embodiment. These user databases 341, 342, 343 may log transaction and system information, user activities and user statistics, and synchronize over a network 311, such as the Internet. In one embodiment, user database 341 may be maintained separately from its respective server 301 in order to provide increased security and so that server 301 can more fully use its processing power to run RTB auctions and communicate with suppliers and buyers of ad space. Alternatively, database 341 and respective server 301 may be integrated into a single machine or device.

Although FIG. 3 depicts exchange 130 as a distributed network, it should be appreciated that any one or more of consumer 110's computing device, publisher 120, advertiser 140, SSP 150, DSP 160, and ad agency 170 may be similarly configured.

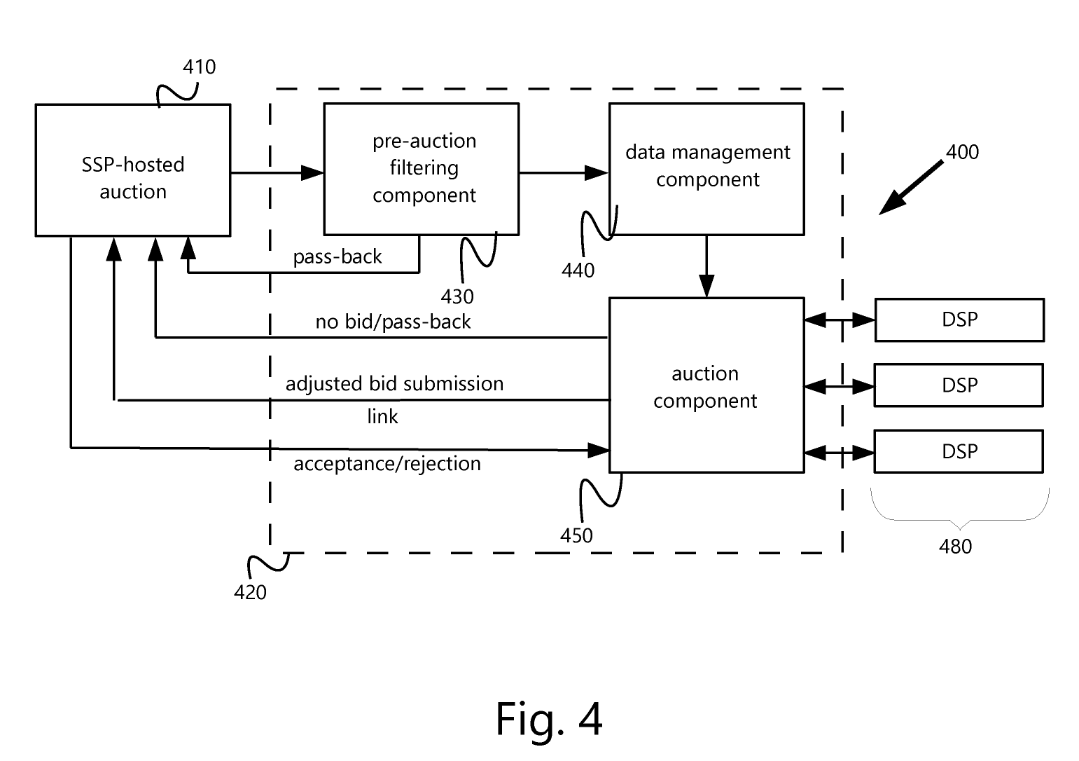

FIG. 4 depicts an exemplary embodiment of an RTB exchange 420 within environment 400. In one aspect, environment 400 may comprise an SSP 410, RTB exchange 420, and one or more DSPs 480. In an alternative embodiment, SSP 410 may be a web publisher rather than a supply side platform. Similarly, DSPs 480 may comprise one or more SSPs, ad agencies, trade desks, exchanges, and/or advertisers, rather than or in addition to demand side platforms.

In another aspect, RTB exchange 420 may comprise a filtering component 430, a data management component 440, and an auction component 450. Of course, RTB exchange 420 may comprise additional, fewer, or alternative components to those depicted in FIG. 4, including but not limited to a viewability component and/or a waterfall component, which are described below with respect to other embodiments.

As described earlier, in some instances, a publisher or SSP may host its own auction for the sale of inventory located on a webpage. This auction may be substantially similar to the auction described above that is conducted by exchange 130. For example, SSP 410 may receive an ad request from an associated publisher and, in response, transmit one or more bid requests to participating SSPs, DSPs, and exchanges. In such an embodiment, RTB exchange 420 may be configured to receive such bid requests from SSP 410. The bid request may be substantially similar to the bid request described above with respect to FIG. 1, however, other types or forms of bid or ad requests and/or bid/ad requests comprising more, less, or different information may also be transmitted from SSP 410 to exchange 420. In one embodiment, the bid request may be received at filtering component 430. Filtering component may be configured to extract information from the ad request and perform one or more screening operations pertaining to that information. For example, filtering component 430 may compare information extracted from the bid request to one or more criteria. In some embodiments, where the bid request contains information that does not meet one or more criteria, filtering component 430 may reject the bid request and send a rejection message back to SSP 410. Alternatively, where the bid request contains information that does meet one or more criteria, the information extracted from the bid request may be transmitted to another component of exchange 420 such as data management component 440. Further details regarding filtering component 430 are described below with respect to other figures.

Within data management component 440, information extracted from the bid request may be compared and/or cross-referenced with information previously-stored by exchange 420. For example, exchange 420 may possess or have access to additional information pertaining to, among other things, particular IP addresses, consumers, web publishers, and/or webpages. This information may have been collected in conjunction with past transactions involving other bid or ad requests, or the information may have been purchased from a third party data collector. In this manner, when data management component 440 receives information extracted from a bid request from filtering component 430, that information can be compared to the previously-stored information in order to generate or collect additional data regarding the particular transaction. For example, where information extracted from the bid request comprises a publisher identifier and the previously-stored information contains a record associating that publisher identifier with information indicative of a high-value publisher, that data may be helpful to exchange 420 and/or DSPs 480 when making a determination as to whether to buy or bid for the inventory associated with the bid request.

A portion or all of the information extracted from the bid request and/or the information recalled or generated based on the previously-stored information may then be transmitted from data management component 440 to auction component 450. In one embodiment, auction component 450 may comprise an interface or communication channel with one or more DSPs 480 interested in buying advertising inventory. Auction component 450 may provide an environment in which DSPs 480 may view, receive, or otherwise evaluate information pertaining to the associated advertising inventory and make a determination regarding whether to buy the inventory and/or how much to bid for the inventory within the auction. For example, as described above, auction component 450 may generate a new bid request comprising information associated with the inventory and transmit the bid request to one or more potential buyers of the inventory (i.e., SSPs, DSPs, exchanges, and advertisers).

In another embodiment, where a DSP (or other recipient of the bid request) evaluates the bid request and decides to bid on inventory, a bid comprising a DSP/purchaser identifier, a bid price, and a link to an advertisement may be communicated to exchange 420 at auction component 450. In this manner, should the bidding DSP win the auction, exchange 420 will already be in possession of a link to the advertisement that the DSP desires to display at the associated webpage. Of course, a bid transmitted from a DSP may contain additional, less, or alternative information.

As discussed above, the auction for the advertising inventory may remain open for the submission of bids for a predetermined period of time, e.g., 50-100 milliseconds, or until some other condition is satisfied. Of course, the duration of the auction may be longer or shorter than 50-100 milliseconds and/or be determined based, at least in part, on a number of relevant conditions.

After the auction is closed to further bidding, a winning bidder may be determined. In instances where no bids were received or no bids were received above a predetermined floor price, exchange 420 may transmit a pass-back or rejection message to SSP 410 notifying SSP 410 that the inventory will not be purchased or that no bid will be submitted to SSP 410 from exchange 420. Conversely, in instances where a satisfactory winning bid is received at auction component 450, the winning bid may then be transmitted, along with a link to the associated advertisement, from exchange 420 to SSP 410. Where SSP 410 is hosting its own auction for the advertising inventory, SSP 410 may compare the winning bid transmitted by exchange 420 to other bids for the same inventory submitted to SSP 410 by other entities. SSP 410 may then send a confirmation message to exchange 420 where the bid transmitted from exchange 420 is sufficient to win the auction held by SSP 410. Alternatively, SSP 410 may transmit a rejection or losing bid message to exchange 420 where the bid transmitted from exchange 420 to SSP 410 is insufficient to win the auction held by SSP 410.

In the event that exchange 420 receives a confirmation message from SSP 410 indicative that SSP 410 has accepted the bid price transmitted by exchange 420 for the inventory, a second confirmation message may then be transmitted from exchange 420 to the DSP that submitted the winning bid at auction component 450, informing the winning DSP of the placement of the ad at the location of the inventory. Any financial transactions between the parties may then be scheduled. For example, SSP 410 may invoice exchange 420 for the purchase of the inventory, and exchange 420 may invoice the winning DSP for the purchase of the inventory.

In one aspect, where exchange 420 receives one or more bids at auction component 450, and prior to transmitting a winning bid and advertising link to SSP 410 that may be hosting its own auction, exchange 420 may modify or adjust the winning bid amount in order to increase or maximize win rates, volume and liquidity within the exchange. In one embodiment, this may be accomplished by increasing the winning bid amount received at auction component 450 prior to transmitting a bid to SSP 410. For example, exchange 420 may increase a winning bid amount received from a DSP (or other auction participant) by a percentage, e.g., 10%, prior to transmitting a bid to SSP 410. Of course, in other embodiments, exchange 420 may increase a winning bid received at auction component 450 by a percentage less than or greater than 10%.

The adjusted or modified bid may then be transmitted to SSP 410 and, because the bid amount has been increased prior to transmission from exchange 420, the modified bid is more likely to be the highest bid. Thus, the DSP or auction participant who submitted the initial bid through exchange 420 is more likely to win the SSP-hosted auction and have their advertisement placed at the location of the inventory.

As described above, many RTB auctions for internet advertising inventory are conducted using a modified Vickrey system in which the winning bidder pays the price bid by a second place bidder. In this manner, even if the modified bid represents a 10%, 20%, or 30% increase from the initial bid received from a DSP or other exchange-hosted auction participant, where the modified bid transmitted by exchange 420 is the high bid within the SSP-hosted auction, the exchange may only have to pay the amount bid by the second-highest bidder within the SSP-hosted auction. Thus, in many instances, the exchange may not ultimately have to pay the modified bid amount.

From the perspective of the DSPs and other exchange-hosted auction participants, these systems and methods are advantageous because the bids being submitted to the SSP-hosted auctions by exchange 420 are being adjusted upward, thereby increasing the chances that the DSP ultimately wins the auction and is able to place its advertisement at the location of the inventory, despite not having to pay more for the inventory than the initial bid amount submitted to exchange 420.

Nonetheless, these systems and methods are also advantageous to exchange 420. For example, many more DSPs and auction participants may decide to submit bids for inventory through exchange 420 rather than other entities because, as a result of the bid modification process, submitting bids through exchange 420 is likely to result in greater win rates on their bids. Further, because the auction may be conducted using a modified Vickery system, in many instances, despite the fact that the bid submitted to exchange 420 has been increased or adjusted upward, the winning bid within the SSP-hosted auction may actually be less than the initial bid submitted to auction component 450. This would result in a small profit for exchange 420. Because exchange 420 may be handling more volume based on their modified bid submission process, a greater volume of small profit transactions results in larger overall profits (in the aggregate) for exchange 420. In fact, depending upon the circumstances of each individual transaction, the number of instances in which exchange 420 may have to pay SSP 410 a winning bid amount above the initial bid amount submitted at auction component 450 may be relatively small.

In alternative embodiments to the one depicted in FIG. 4, rather than SSP 410 hosting an auction an transmitting a bid request to exchange 420, SSP 410 may transmit an ad request to exchange 420 as part of SSP 410's waterfall process(es). A waterfall process is described in more detail below. In a further embodiment, SSP 410 may transmit an ad request to exchange 420 comprising a predetermined price associated with for-sale inventory. In fact, exchange 420 may receive any form of ad request or offer for sale associated with advertising inventory from SSP 410, i.e., inventory offered through any suitable sales platform or sales channel. Regardless of the inventory offer form (bid request, ad request, offer for sale, etc.), exchange 420 may handle any such request or offer for sale that may be received from SSP 410 similar to the bid request described above with respect to FIG. 4, i.e., filter information associated with the ad request, collect additional information associated with the ad request, hold a real-time auction for the associated inventory, and/or modify the amount of the winning bid in the auction. In embodiments where SSP 610 is not hosting its own auction, rather than exchange 620 transmitting a bid request comprising the modified bid amount to SSP 610, exchange 620 may transmit an acceptance of the ad request initially transmitted from SSP 610 to exchange 620.

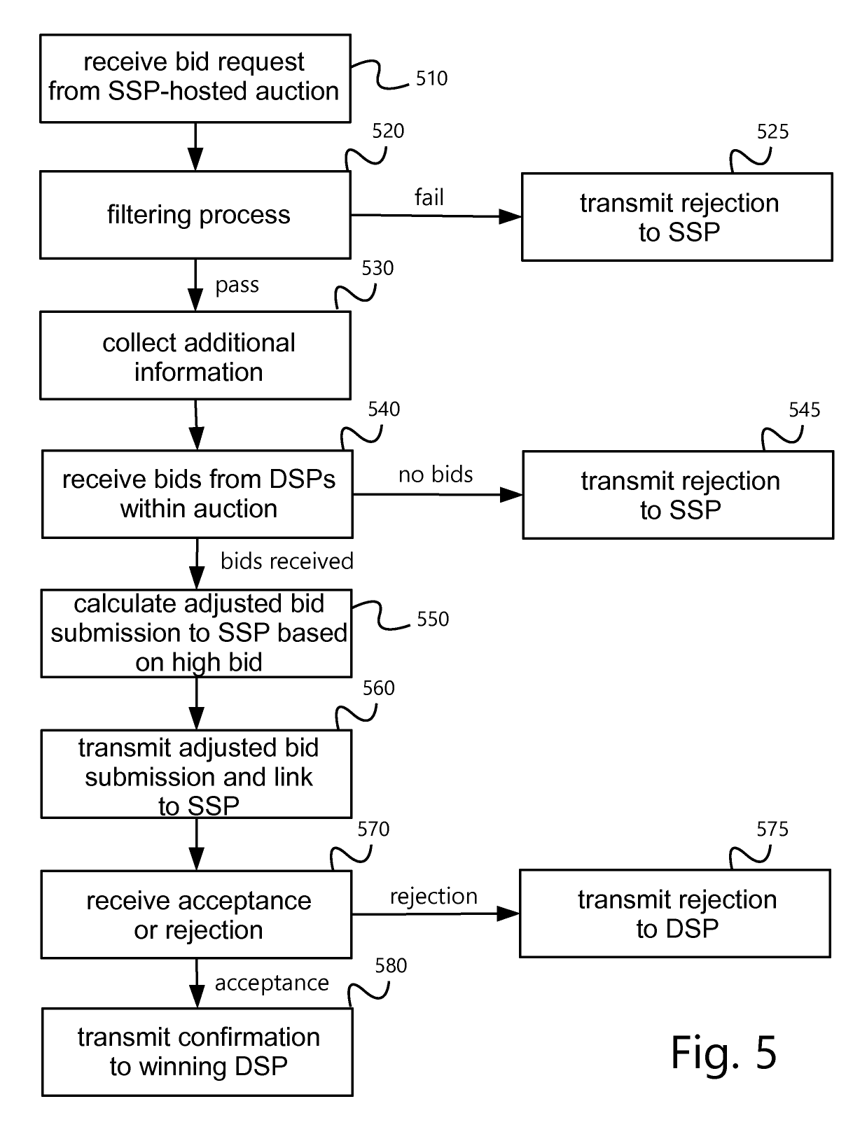

FIG. 5 depicts an exemplary embodiment of a method for purchasing advertising inventory using the aforementioned modified bid submission process. In one aspect, at step 510, exchange 420 may receive a bid request from SSP 410, soliciting a bid at an auction hosted by the SSP. The bid request received from SSP 410 may or may not be substantially similar to the bid/ad requests described above.

In another aspect, information associated with the bid request may be extracted, screened, or analyzed by exchange 420 as part of a filtering process at step 520. For example, exchange 420 may compare information extracted from the bid request to one or more criteria. In some embodiments, where the bid request contains information that does not meet one or more criteria, exchange 420 may reject the bid request and send a rejection message back to SSP 410 at step 525. Alternatively, where the bid request contains information that satisfies one or more criteria, the information extracted from the bid request may be used to cross-reference a database and collect additional data associated with the transaction at step 530.

For example, information extracted from the bid request may be compared and/or cross-referenced with information previously-stored by exchange 420. Exchange 420 may possess or have access to additional information pertaining to, among other things, particular IP addresses, consumers, web publishers, and/or webpages. This information may have been collected in conjunction with past transactions involving other bid or ad requests, or the information may have been purchased from a third party data collector. The additional data associated with the transaction may be helpful to exchange 420 and/or exchange-hosted auction participants when setting an auction reserve price or making decisions as to whether to buy or bid for the inventory associated with the bid request.

Although FIG. 5 depicts the filtering process (step 520) occurring prior to the additional data collection process (step 530), it should be noted that these steps may be reversed in alternative embodiments. Additional details regarding the filtering process and data collection process are discussed below with respect to other embodiments.

At step 540, any portion or all of the information extracted from the bid request and/or the additional data collected may be transmitted or otherwise communicated to exchange-hosted auction participants in conjunction with a bid request transmitted by exchange 420. This bid request may or may not be substantially similar to the bid/ad requests described above. In one embodiment, exchange 420 may maintain an interface or communication channel with one or more DSPs, SSPs, exchanges, advertisers, etc. interested in buying advertising inventory. Upon receipt of the bid request, the recipients/auction participants may review or otherwise evaluate information associated with the bid request and pertaining to the advertising inventory in order to make a determination regarding whether to buy the inventory and/or how much to bid for the inventory within the exchange-hosted auction.

As described above, where an auction participant evaluates the bid request and decides to bid on inventory, a bid comprising a DSP/purchaser identifier, a bid price, and a link to an advertisement may be communicated to exchange 420. In this manner, should the bidding DSP win the exchange-hosted auction and the subsequent SSP-hosted auction, exchange 420 (and, in turn, SSP 410) will already be in possession of a link to the advertisement that the DSP desires to display at the associated webpage. Of course, a bid transmitted from a DSP may contain additional, less, or alternative information.

Once the exchange-hosted auction is closed to further bidding, a winning bidder may be determined. In instances where no bids were received or no bids were received above a predetermined reserve price, exchange 420 may transmit a pass-back or rejection message to SSP 410 at step 545, notifying SSP 410 that the inventory will not be purchased or that no bid will be submitted to the SSP-hosted auction from exchange 420.

In instances where a satisfactory bid has been received by exchange 420, the winning or high bid may be modified or adjusted prior to transmission to the SSP-hosted auction. In one embodiment, the high bid may be increased by, for example, 10% prior to transmission to the SSP-hosted auction. In other embodiments, of course, the high bid may be increased or decreased by more or less than 10%. Alternatively, the high bid may be increased or decreased by a flat amount rather than a percentage. Other bid modifications are also possible and those described herein should not be considered exhaustive of the possibilities.

At step 560, the modified bid amount may be transmitted, along with a link to the associated advertisement, from exchange 420 to the SSP-hosted auction. Within the SSP-hosted auction, at step 570, the modified bid may then be compared to other bids for the same inventory submitted to SSP 410 by other entities in order to determine whether to accept or reject the modified bid. In instances where the modified bid submitted by exchange 420 is insufficient to win the SSP-hosted auction, SSP 410 may transmit a rejection or losing bid message to exchange 420 at step 575. Alternatively, where the modified bid submitted by exchange 420 is determined to be the winning or high bid, SSP 410 may transmit a confirmation or acceptance message to exchange 420 at step 580. A subsequent confirmation or acceptance message may then be transmitted from exchange 420 to the winning bidder of the exchange-hosted auction, informing the winning bidder of the placement of an advertisement at the location of the inventory. The parties, e.g., the SSP, exchange, and DSP, may then settle any financial aspects of the transaction, as described previously.

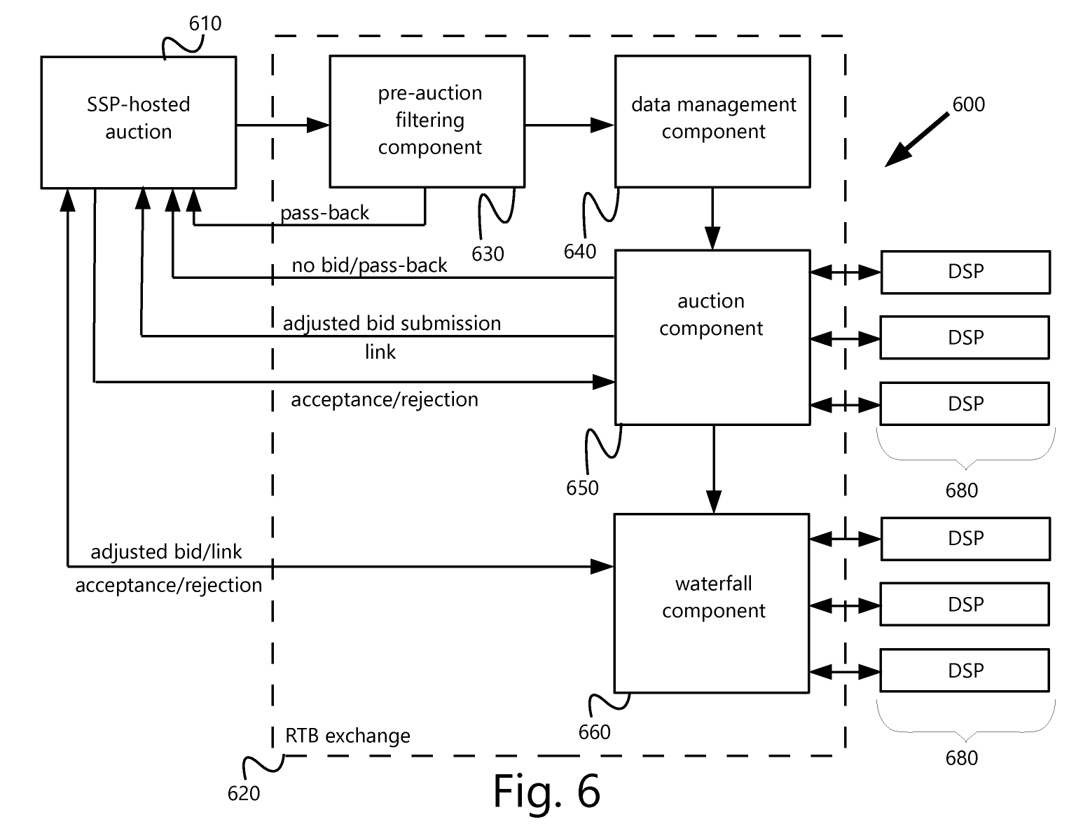

FIG. 6 depicts an exemplary embodiment of an RTB exchange environment 600. Like environment 400, environment 600 may comprise an SSP 610, an RTB exchange 620, and one or more DSPs 680. Further, SSP 610 may be a web publisher rather than a supply side platform and DSPs 680 may comprise one or more SSPs, exchanges, ad agencies, and/or advertisers, rather than or in addition to one or more demand side platforms. In alternative embodiments, environment 600 may comprise additional, fewer, or alternative components.

RTB exchange 620 may be substantially similar to exchange 420 depicted in FIG. 4, comprising a filtering component 630, a data management component 640, and an auction component 650. Of course, exchange 620 may comprise additional, fewer, or alternative components. Moreover, the components of exchange 620 may be configured substantially similar to the corresponding components of exchange 420.

In exchange 420, however, a pass-back or rejection message is transmitted to SSP 410 in instances where no bids are received from DSPs 1380 at exchange 420 or no bids are received from DSPs 480 above a predetermined floor/reserve price. In exchange 620, rather than generating or transmitting such a pass-back or rejection message to SSP 610, inventory that receives no bids or receives no satisfactory bids in auction component 650, i.e., unsold inventory, may be transmitted to a modified waterfall component 660.

Modified waterfall component 660 may be associated or in communication with a database storing information pertaining to past purchase behavior of one or more DSPs, SSPs, ad agencies, and advertisers. Moreover, the database may contain information useful in determining the identity of the DSP, SSP, ad agency, or advertiser most likely to purchase the unsold inventory and information indicative of the price such a buyer may be willing to pay for the unsold inventory. Thus, modified waterfall component 660 may generate an ad request substantially similar to the ad requests described previously that is associated with the unsold inventory and transmit the ad request to the DSP, SSP, ad agency, or advertiser most likely to purchase the unsold inventory at the highest price, i.e., the first waterfall recipient. In one embodiment, the ad request contains information pertaining to the inventory and a price for placement of the advertisement at a location of the inventory. Where the first waterfall recipient decides to purchase the unsold inventory at the requested price, the first waterfall recipient may transmit a confirmation message to exchange 620 comprising a link to the advertisement desired to be displayed at the location of the inventory. In instances where the first waterfall recipient decides not to purchase the unsold inventory, a pass-back or rejection message may be transmitted to exchange 620.

Where a pass-back or rejection message is received from the first waterfall recipient, modified waterfall component 660 may then transmit an ad request to a second waterfall recipient of the remaining potential buyers, the second waterfall recipient now being the most likely to purchase the unsold inventory at the highest price. In one embodiment, this second ad request may be substantially similar to the ad request transmitted to the first waterfall recipient. This iterative process may repeat until a willing buyer of the unsold inventory is found.

Once a willing purchaser of the inventory is found at a predetermined price, and similar to environment 400 where SSP 410 is conducting its own auction for the inventory, waterfall component 660 may adjust or modify the predetermined price agreed to by the most recent waterfall recipient prior to transmitting the bid to SSP 610 in order to increase or maximize win rates, volume and liquidity associated with inventory handled by the exchange. For example, in one embodiment, the price agreed to by the latest waterfall recipient may be increased by 10% prior to transmission of a bid to the SSP-hosted auction. In other embodiments, of course, the predetermined price may be increased or decreased by more or less than 10%. Alternatively, the predetermined price may be increased or decreased by a flat amount rather than a percentage. Other price modifications are also possible and those described herein should not be considered exhaustive of the possibilities.

Once the modified/adjusted bid has been calculated, exchange 620 may transmit the adjusted bid to SSP 610 along with a link to the associated advertisement that the latest waterfall recipient would like placed at the location of the inventory. Thus, where the adjusted bid is selected as the winning bid within the SSP-hosted auction, SSP 610 is already in possession of the link to the advertisement for display at the webpage and may transmit a confirmation message back to exchange 620. On the other hand, where the adjusted bid is not selected as the winning bid, SSP 610 may transmit a rejection or losing bid message to exchange 620. Exchange 620 may then, in turn, generate and/or transmit a message to the latest waterfall recipient indicative of a completed transaction or an unsuccessful bid.

In alternative embodiments to the one depicted in FIG. 6, rather than SSP 610 hosting an auction an transmitting a bid request to exchange 620, SSP 610 may transmit an ad request to exchange 620 as part of SSP 610's own waterfall process(es) substantially similar to the waterfall process described above with respect to exchange 620. Additional details regarding waterfall processes are described in more detail below. In a further embodiment, SSP 610 may transmit an ad request to exchange 620 comprising a predetermined price associated with for-sale inventory. In fact, exchange 620 may receive any form of ad request or offer for sale associated with advertising inventory from SSP 610, i.e., inventory offered through any suitable sales platform or sales channel of SSP 610. Regardless of the inventory offer form (bid request, ad request, offer for sale, etc.), exchange 620 may handle any such ad request or offer for sale that may be received from SSP 410 similar to the bid request described above with respect to FIG. 6, i.e., filter information associated with the ad request, collect additional information associated with the ad request, hold a real-time auction for the associated inventory, initiate a waterfall where no satisfactory bids are received, and/or modify the amount of the sale price agreed to by the latest waterfall recipient. In embodiments where SSP 610 may not be hosting its own auction, rather than exchange 620 transmitting a bid request comprising the modified bid amount to SSP 610, exchange 620 may transmit an acceptance of the ad request or offer for sale initially transmitted from SSP 610 to exchange 620.

In still further embodiments, rather than exchange 620 hosting an auction prior to initiating a waterfall process as described above, exchange 620 may initiate the aforementioned waterfall process without holding an auction for the for-sale inventory, i.e., upon receiving an ad request, bid request, or offer for sale from SSP 610, exchange 620 may filter information associated with the request/offer, collect additional information associated with the ad request, initiate a waterfall, and/or modify the amount of the sale price agreed to by the latest waterfall recipient before transmitting a bid or acceptance to SSP 610.

Further details regarding waterfall component 660 and the prioritization of a plurality of potential buyers of unsold inventory is described below with respect to other figures.

### Viewability Overview

In addition to those aspect described previously, exemplary embodiments herein allow an entity, such as an exchange, to purchase inventory or ad space as part of a real-time bidding auction. As explained above, the ad space may be located within content, such as a webpage, being loaded on a user computing device. But instead of placing a traditional advertisement within the space, an exemplary embodiment herein may supply a self-monitoring ad tag. The self-monitoring ad tag may be executed by the user computing device to locally monitor events, causing the user computing device to request resale of the ad space at an optimal time.

This may allow an exchange to purchase an ad space for a relatively low price and then resell it for a higher price. For example, once the location of the ad space (i.e., also the location of the self-monitoring ad tag) becomes viewable, ad space at the viewable location may be worth much more money to advertisers than ad space at an unknown location (which might never be viewed by the user). Thus, the self-monitoring ad tag may cause the user's computing device to monitor viewability of the ad space location, in addition to monitoring other user activities and potentially-valuable context, and initiate a resale when conditions are optimal. In this way, the exchange may use its own auctions and/or SSP auctions to buy low and sell high.

When the self-monitoring ad tag becomes viewable, it may cause the user's computing device to contact a second RTB auction (e.g., at the exchange or a different exchange) that exclusively sells viewable ad space. Special arrangements with advertisers bidding at the second RTB auction may facilitate greater financial returns in one embodiment.

The self-monitoring ad tag may also initiate a sale to avoid losses when conditions indicate the user may not view the ad space before navigating away from the surrounding content (e.g., by closing the browser or visiting a new website).

For simplicity, the content where the self-monitoring ad tag is placed may be discussed herein as a webpage or website, but that is just one example of content. Embodiments described herein also operate with other types of content, such as a video, movie, television show, software application, e-book, e-mail, music streaming app, video game, or any other type of content where at least a portion containing the ad space is delivered over and/or has access to the Internet. Thus, none of the embodiments herein are limited to only a webpage or website, and the concepts herein also apply to other types of content.

Similarly, it is contemplated that embodiments herein may acquire ad space through a purchase, sale, resale, buy, joint venture, compartmentalization, or any other method of acquisition. Use of terms such as “bid,” “buy” or “purchase” are not limiting with regard to how the ad space is acquired (e.g., auction or waterfall), but are used broadly to apply to any programmatic sales transaction. Similarly, the term sale can include a resale, and sell and can include resell, unless otherwise specified.

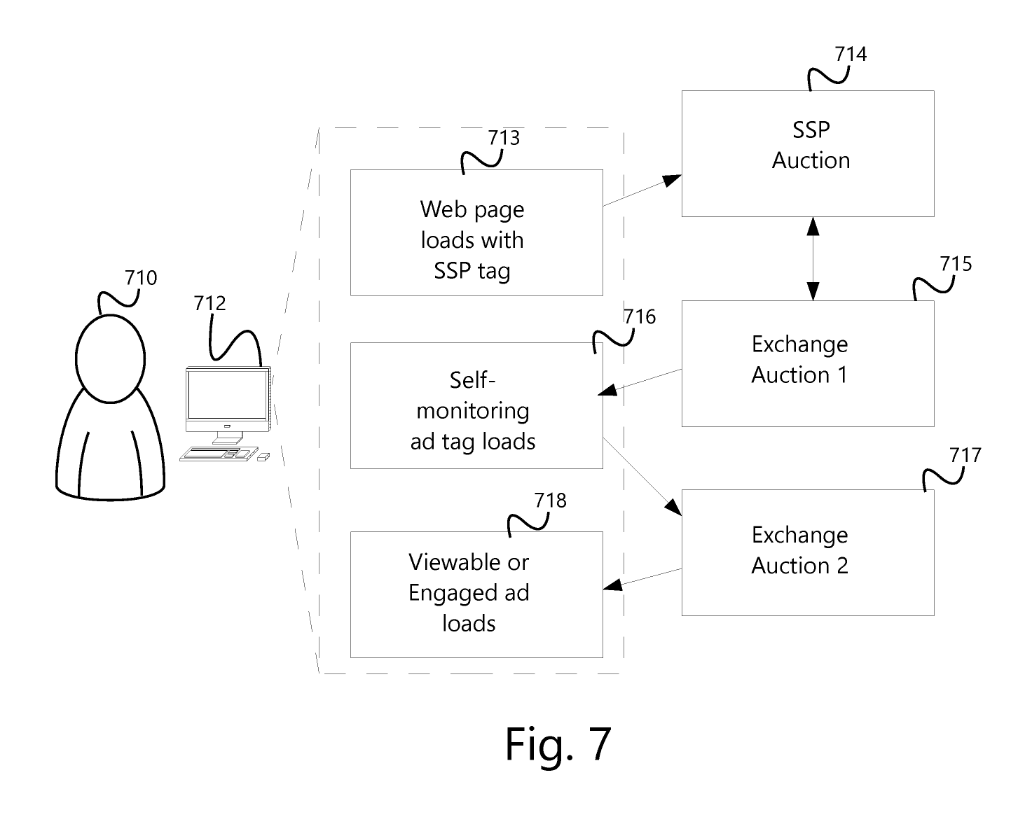

FIG. 7 depicts an exemplary embodiment of a network of auction platforms/components for distributing self-monitoring ad tags that solicit real-time advertisement bids. In one aspect, a user 710 at a computing device 712 may attempt to view content, such as a webpage, on the computing device 712. The webpage may have an SSP's ad tag hard-coded into it. Stages 713, 716, and 718 represent functions that may be performed locally at the computing device 712.

At stage 713, when the webpage loads, the computing device may execute the SSP's tag, causing the computing device 712 to contact an SSP auction platform 714. The SSP auction platform 714 may then execute an automated auction to sell ad space on the webpage being loaded by the user 710 at computing device 712.

As part of the SSP auction, the SSP may contact an exchange with a bid request. The bid request may identify the source of the content (e.g., a particular webpage), the ad space (e.g., an ad space identifier), and/or the computing device 712 (e.g., a user ID). In response to the bid request, the exchange may then hold its own first auction 715, soliciting bids for the ad space being offered by the SSP, and forwarding the winning bid of the exchange auction to be placed as a bid in the SSP auction.

In some cases (as will be described more fully herein), the exchange will determine that it should bid on the ad space itself, and if it has the high bid in its own auction (i.e., the first exchange auction), the exchange will pass its own bid back into the SSP auction 714. If the exchange ultimately wins the SSP auction 714, the SSP and/or exchange then deliver the exchange's self-monitoring ad tag to the computing device instead of delivering a traditional advertisement. In an alternative embodiment, rather than hosting the first auction, the exchange may simply submit its own bid for the ad space at the SSP auction.

Regardless, where the exchange ultimately wins the SSP auction, computing device 712 then loads the self-monitoring ad tag at block 716, which may cause computing device 712 to monitor user activity and wait for an optimal time to resell the ad space. In particular, if the ad space is in viewable (e.g., in view for 3 seconds) or engaged (i.e., moving into view), the self-monitoring ad tag may cause computing device 112 to contact a second exchange auction platform 217 to resell the ad space at a premium based at least partially on the “viewable” or “engaged” status. “Viewable” may be sold at a premium compared to non-viewable, and “engaged” may be sold at a premium to even viewable in one embodiment. For example, an engaged ad may be more likely to be clicked than one that is merely viewable.

The second exchange auction platform 217 may then hold an auction for the ad space that may be a viewable-only auction (which may also include engaged ad space or be solely for engaged ad space in one embodiment), commanding higher prices from advertising entities based on the certainty that a placed advertisement will be in view or engaged. Once the second exchange auction platform determines the winner, the exchange may then place the winner's advertisement by communicating it back to the computing device 712. At stage 718, the computing device 712 may load the viewable or engaged ad of the winning bidder.

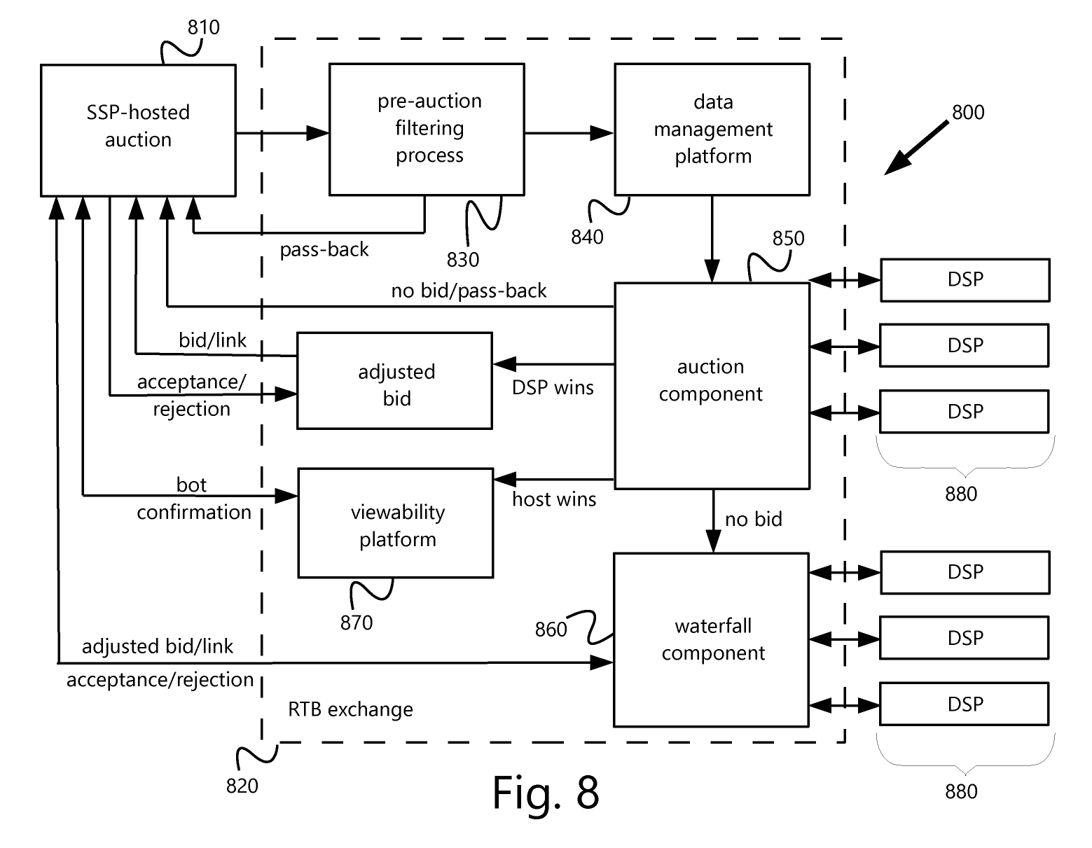

FIG. 8 depicts an exemplary embodiment of an RTB exchange environment 800. Like environment 600 depicted in FIG. 6, environment 800 may comprise an SSP 810, an RTB exchange 820, and one or more DSPs 880. Further, SSP 810 may be a web publisher rather than a supply side platform and DSPs 880 may comprise one or more SSPs, exchanges, ad agencies, and/or advertisers, rather than or in addition to one or more demand side platforms. In alternative embodiments, environment 800 may comprise additional, fewer, or alternative components.

RTB exchange 820 may be substantially similar to exchange 620 depicted in FIG. 6, comprising a filtering component 830, a data management component 840, an auction component 850, and a waterfall component 860. Of course, exchange 820 may comprise additional, fewer, or alternative components. Moreover, the components of exchange 820 may be configured substantially similar to the corresponding components of exchange 620.

Exchange 820 may further comprise a viewability component 870. In one aspect, upon consideration of information extracted from the bid/ad request and/or previously-stored in association with data management component 840, exchange 820 may decide to place a bid for the inventory within its own auction component 850. In such circumstances, and where exchange 820 submits the winning bid to auction component 850, information regarding the inventory and/or winning bid information may be transmitted to viewability component 860. In an alternative embodiment, exchange 820 may forego placing inventory associated with a received bid/ad request up for auction. In such an embodiment, DSPs 880 may not be presented with an opportunity to purchase the inventory.

From viewability component 860, the winning bid or a bid price determined by exchange 820 may be transmitted, along with an ad tag, from exchange 820 to SSP 810. Where SSP 810 is hosting its own auction for the advertising inventory, SSP 810 may evaluate the bid or compare the bid transmitted by exchange 820 to other bids for the same inventory submitted to SSP 810 by other entities. SSP 810 may then send a confirmation or acceptance message to exchange 820 where the bid transmitted from exchange 820 is sufficient to win the auction held by SSP 810. Alternatively, SSP 810 may transmit a rejection or losing bid message to exchange 820 where the bid transmitted from exchange 820 to SSP 810 is insufficient to win the auction held by SSP 810.

The ad tag transmitted from exchange 820 may then be served to the location of the inventory or ad space where it may actively monitor a user's computing device and/or a user's interactions with his or her web browser. In another aspect, where the ad tag determines that the location of the inventory may be viewable or may become viewable in a predetermined amount of time, the ad tag may initiate or trigger another auction for the inventory through exchange 820.

Additional details regarding viewability features and embodiments comprising various viewability aspects are more thoroughly described in U.S. patent application Ser. No. 14/058,179, filed Oct. 18, 2013 and incorporated herein by reference.

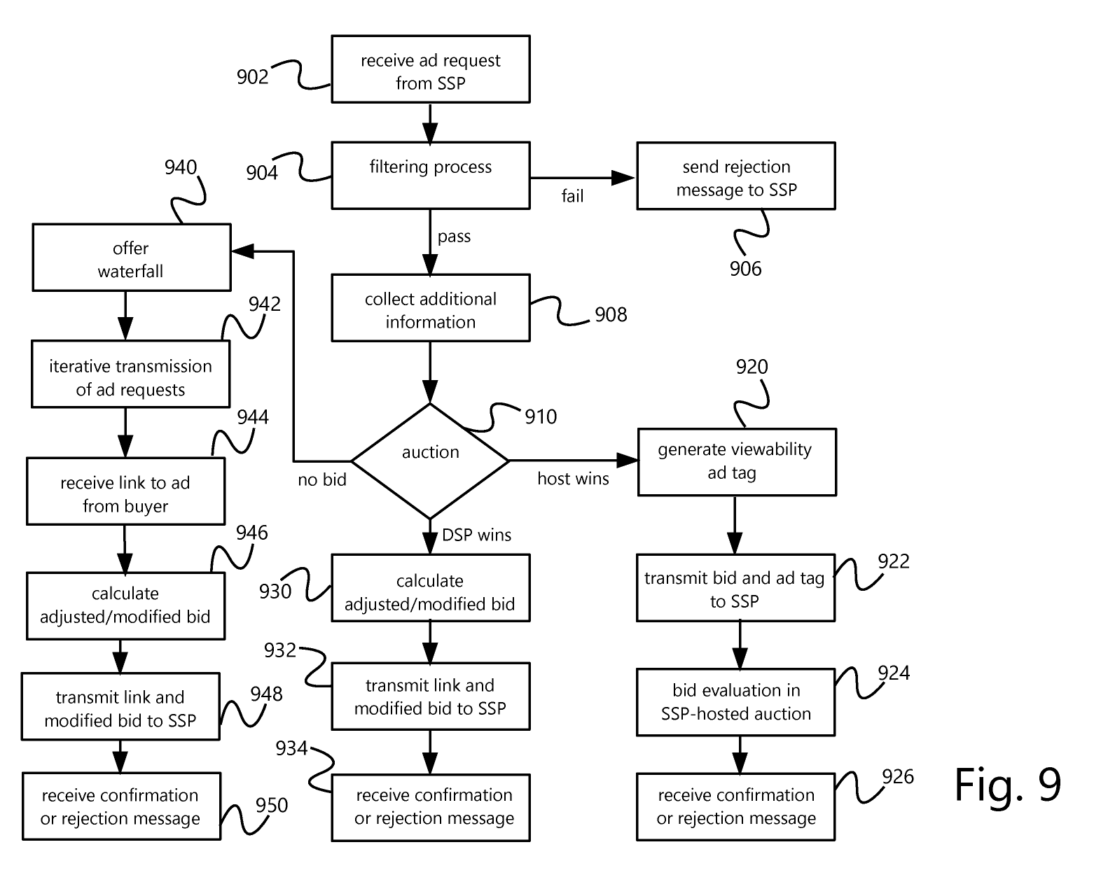

FIG. 9 depicts an exemplary embodiment of a method for placing an advertisement or ad tag at the location of inventory. At step 902, the RTB exchange may receive a bid or ad request from an SSP or directly from a web publisher that is conducting its own auction for ad space/inventory. The bid request may be substantially similar to the bid request described above with respect to previous figures, however, other types or forms of bid and ad requests and/or bid/ad requests comprising more, less, or different information may also be received from the SSP or web publisher.

At step 904, information may be extracted from the bid/ad request and that information may be compared against one or more filtering or screening criteria to determine if the inventory is suitable for sale within the exchange. Further details regarding the filtering or screening process are described below.

Where the inventory associated with the ad request does not meet one or more criteria, the exchange may not accept the inventory and, at step 906, may transmit a rejection message to the SSP. The rejection message can indicate that the inventory was rejected and/or will not be sold through the exchange. In another embodiment, the rejection message may describe one or more criteria that the inventory failed to satisfy and/or otherwise explain why the inventory has been rejected.

Where the inventory does meet one or more criteria, the information extracted from the ad request may then be used to identify additional information accessible to the exchange at step 908. For example, the exchange may possess or have access to additional information pertaining to, among other things, particular IP addresses, consumers, web publishers, and/or webpages. This information may have been collected in conjunction with past transactions involving other ad requests, or the information may have been purchased from a third party data collector. In one embodiment, extracted information from the ad request may be used to cross-reference one or more databases in order to gather the additional information. Further details regarding the collection of additional information pertaining to inventory associated with received ad requests are described below with respect to other figures.

At step 910, a portion or all of the information extracted from the ad request and/or the additional information may then be transmitted to an auction environment. In one aspect, one or more DSPs or other entities interested in purchasing advertising inventory may view, receive, or otherwise evaluate information pertaining to inventory made available for purchase through the auction. In one embodiment, as inventory is made available within the auction environment, a transmission is sent to one or more potential buyers, the transmission comprising one or more of: a notification that the inventory is available for purchase; information describing the inventory, such as the webpage on which it resides, consumer information, publisher information, and the number of advertisements on the webpage; a reserve price for bids and/or an opening bid amount. In response, one or more potential buyers may then submit bids to the exchange for the inventory. In conjunction with the bids, a buyer identifier and/or a link to an advertisement desired to be displayed at the location of the inventory may also be provided.

Upon conclusion of the auction, a winning bidder may be selected. In instances where the exchange submitted a bid on its own behalf, e.g., as part of a viewability feature described previously, a viewability ad tag may be generated at step 920. At step 922, the ad tag may then be transmitted to the SSP or web publisher selling the inventory along with a bid for the inventory, e.g. the amount of the winning bid within the exchange-hosted auction. After transmission of the ad tag, at step 924, the bid submitted by the exchange may be evaluated within the SSP-hosted auction, i.e., the exchange's bid may be compared to other bids submitted to the SSP-hosted auction by other entities. In instances where the exchange's bid is not the high bid, the exchange may receive a rejection message from the SSP/web publisher informing the exchange that the offer to buy the inventory has not been accepted at step 926. Alternatively, at step 926, in instances where the exchange's bid is the highest or most desirable bid, the exchange may receive a confirmation message from the SSP/web publisher informing the exchange that the offer to buy the inventory has been accepted and the ad tag has been placed at the location of the inventory.

In another aspect, at step 930, where a DSP or other bidding party wins the auction rather than the exchange, the exchange may modify or adjust the winning bid amount as described previously in order to increase win rates, volume and liquidity within the exchange-hosted auction(s). Once the winning bid has been modified or adjusted, the exchange may transmit the link to the advertisement associated with the winning bidder along with the modified bid to the SSP/web publisher at step 932. At step 934, after transmission of the link and modified bid, the exchange may receive a message from the SSP/web publisher similar to the message received above with respect to step 926, informing the exchange that the offer for purchase of the inventory was either rejected or it was accepted and the linked advertisement has been or will be displayed at the location of the inventory.

In the event that the exchange did not submit its own bid for the inventory to the auction and no satisfactory bids were received by a potential buyer, i.e., either no bids were received or the highest bid did not meet a reserve price, information pertaining to the inventory may be subjected to an offer waterfall at step 940. There, the information associated with the inventory may be used to cross-reference a database storing information pertaining to past purchase behavior of one or more buyers and the identity of the buyers most likely to purchase the inventory and/or most likely to pay the highest offer price may be ascertained. In this manner, a prioritized list of potential buyers may be generated.

At step 942, the exchange may initiate an iterative process whereby an ad request similar to the bid/ad request initially transmitted by the SSP/web publisher is transmitted to a first recipient, i.e., the potential buyer atop the prioritized list generated at step 940. Where the first waterfall recipient decides to purchase the inventory, the first waterfall recipient may transmit a confirmation message to the exchange comprising a link to the advertisement desired to be displayed at the location of the inventory. In instances where the first waterfall recipient decides not to purchase the unsold inventory, the exchange may receive a pass-back or rejection message. The exchange may then transmit an ad request to a second waterfall recipient newly atop the prioritized list generated at step 940, the second waterfall recipient now being the most likely to purchase the inventory at the highest price. This iterative process may repeat until a buyer of the inventory is found. Further details regarding the offer waterfall and the prioritization of a plurality of potential buyers of inventory is described below with respect to other figures.

Once a buyer of the inventory is found, a link to the advertisement desired to be displayed may be received by the exchange from the latest waterfall recipient at step 944.

At step 946, the predetermined price agreed to by the most recent waterfall recipient may be adjusted or modified, as described above with respect to step 930, prior to transmitting the bid to the originating SSP. By modifying or adjusting the bid amount prior to transmission to the SSP-hosted auction, win rates, volume and liquidity associated with inventory handled by the exchange may be increased or maximized, as described previously herein.

At step 948, after transmission of the link and modified bid, the exchange may receive a message from the SSP/web publisher similar to the message received above with respect to steps 926 and/or 934, informing the exchange that the offer for purchase of the inventory was either rejected or it was accepted and the linked advertisement has been or will be displayed at the location of the inventory.

### Filtering Component

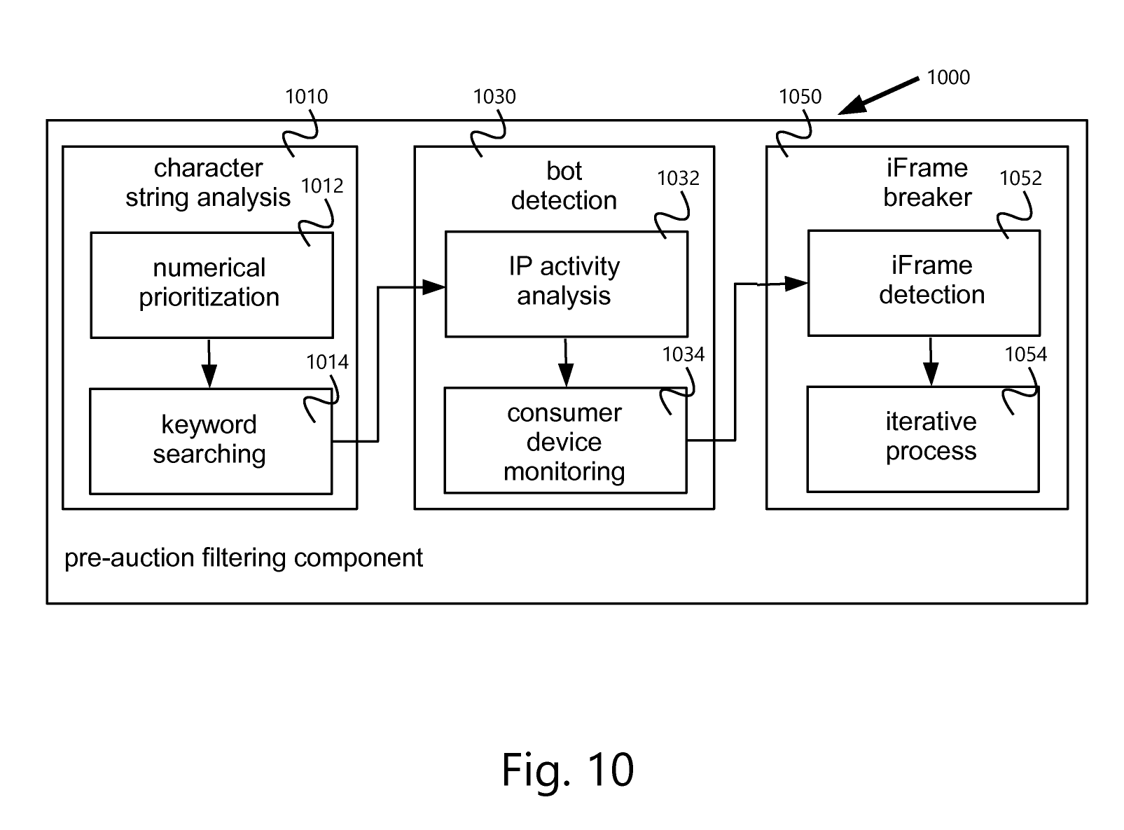

The following is a more detailed description of the filtering component(s)/process(es) described above with respect to FIGS. 4-6, 8 and 9. FIG. 10 depicts an exemplary embodiment of filtering component 1000, which may be substantially similar to filtering component 430 of FIG. 4, filtering component 630 of FIG. 6 and/or filtering component 830 of FIG. 8. As discussed above, an RTB exchange may be configured to receive a bid or ad request from an SSP that may or may not be hosting its own auction for inventory associated with the bid/ad request. The bid or ad request may be substantially similar to the bid/ad requests described previously herein, however, other types or forms of bid and ad requests and/or ad requests comprising more, less, or different information may also be transmitted from the SSP to the exchange.

In one embodiment, the bid/ad request may be received at filtering component 1000, which may be configured to extract information from the bid request and perform one or more screening operations pertaining to that information. For example, filtering component 1000 may compare information extracted from the bid request to one or more criteria. In some embodiments, where the bid request contains information that does not meet one or more criteria, filtering component 1000 may cause the bid request to be rejected and a rejection message to be transmitted back to the SSP. Alternatively, where the bid request contains information that does meet one or more criteria, the information extracted from the bid request may be transmitted to one or more other components of the exchange for further analysis, evaluation, manipulation, and/or transmission.

In one embodiment, filtering component 1000 may comprise a character string analysis component 1010, a bot detection component 1030, and an iFrame breaker component 1050. Of course, these components are exemplary and other embodiments of filtering component 1000 comprising fewer, more, or alternative components are also possible.

As shown in the FIG. 10, information associated with a received bid request may undergo character string analysis, then bot detection, followed by iFrame breaking. In alternative embodiments, however, the order in which the information is subjected to or analyzed by the various components depicted in FIG. 10 may be different. In further embodiments, one or more processes undertaken by one or more of the depicted components or additional components may be carried out simultaneously and/or in an overlapping fashion.

In the embodiment depicted in FIG. 10, information associated with a bid request is first processed by character string analysis component 1010. Character string analysis component 1010 may comprise a numerical prioritization component 1012 and a keyword searching component 1014. Again, although the numerical prioritization is depicted as occurring prior to the keyword searching in FIG. 10, these processes may take place in reverse order, simultaneously, or at overlapping times.

Numerical prioritization component 1012 may be configured to prioritize numerical information contained in the bid request above alphabetical information contained in that bid request. For example, information pertaining to an IP address and contained in the bid request would be represented numerically rather than alphabetically. In this manner, regardless of how information may be presented in the bid request, an IP address may be identified quickly and, for example, cross-referenced against a database containing known “bad” IP addresses. An IP address may be characterized as “bad” for a number of reasons, including but not limited to: past identification as a malicious site (e.g., a site containing nothing but advertising space and little to no substantive content); past association with bot-like activity (i.e., bid requests associated with the IP address have previously been associated with activities indicative of a bot rather than a live person); or past identification as a website associated with restricted content (e.g., pornography or otherwise undesirable web content).

The ability to quickly and efficiently eliminate undesirable bid requests (or bid requests associated with undesirable inventory) from the exchange may be critical, particularly considering the limited time within which the inventory and/or bid request must be transmitted, evaluated, placed up for auction, and/or sold. For example, it is not uncommon that an exchange must evaluate, process, and sell inventory associated with a bid request in approximately 150 ms or less. Of course, the time limitations set on an exchange may be greater or less, and 150 ms is only exemplary. Prioritizing numerical characters so as to quickly identify and cross-reference IP addresses may save a considerable amount of time that would otherwise be spent processing or analyzing a bid request that should eventually be removed from the exchange or, worse, reimbursing a DSP who inadvertently purchases inventory at auction that is associated with malicious or undesirable web content despite representations made by the exchange that it will filter out such inventory.

In one embodiment, where information associated with a bid request is rejected or determined to be undesirable by numerical prioritization component 1012, a message rejecting the bid request and associated inventory may be transmitted to the SSP from which the bid request came without having to analyze the information within the bid request further. Thus, valuable time may be saved.

In another aspect, character string analysis component 1010 may also perform keyword searching on alphabetical characters associated with the information contained in the bid request at keyword searching component 1014. For example, keyword searching component 1014 may search for letters, words, and/or phrases within the bid request information indicative of malicious or undesirable content (e.g.,

“XXX,” “nude,” or “ad pumping”). Further, alphabetical information contained in the bid request may be cross-referenced against a database of known letters, character strings, words, or phrases that have previously been associated with malicious or undesirable web content.

As described above with respect to numerical prioritization component 1012, the ability to quickly and efficiently eliminate undesirable ad requests from the exchange may be critical in light of the limited time within which the inventory and/or bid request must be transmitted, evaluated, placed up for auction, and/or sold. Performing keyword searching on information contained within the bid request quickly or early in the exchange's evaluation process may save a considerable amount of time that would otherwise be spent processing or analyzing a bid request that should eventually be removed from the exchange.

Thus, in some embodiments, where information associated with a bid request is rejected or determined to be undesirable by keyword searching component 1012, a message rejecting the bid request and associated inventory may be transmitted to the SSP from which the bid request came without having to analyze the information within the bid request further, saving valuable time.

Filtering component 1000 may also comprise bot detection component 1030. As depicted in FIG. 10, bot detection component 1030 may comprise an IP activity analysis component 1032 and a consumer device monitoring component 1034. Although the IP activity analysis is depicted as occurring prior to the consumer device monitoring in FIG. 10, these processes may take place in reverse order, simultaneously, or at overlapping times.

In one aspect, IP activity analysis component 1032 may extract or analyze information contained in the bid request associated with the online activity of a particular IP address or web browser. For instance, the bid request may contain cookies or other information indicative of online behavior exhibited by the user/consumer at the IP address or within the consumer's browser. In one embodiment, for example, the number of webpages visited by a consumer within a predetermined period of time may be evaluated. In instances where a consumer has visited a large number of websites in a relatively short period of time, it may be presumed that the consumer is actually a bot generating web traffic rather than a live person or, even if the consumer is a live person, the consumer does not stay on any particular website long enough to view advertisements placed on the visited websites. In an alternative embodiment, rather than evaluating the number of websites an IP address or web browser has visited in a predetermined period of time, IP activity analysis component 1032 may evaluate how many advertisements have been viewed at the IP address or within the browser in a predetermined period of time. In instances where a consumer has viewed a large number of advertisements in a relatively short period of time, it may be presumed that the consumer is actually a bot generating web traffic and attempting to inflate advertising revenue rather than a live person or, even if the consumer is a live person, the consumer may be more concerned with driving advertisements to a webpage than viewing substantive web content.

Thus, in one embodiment, where information associated with a bid request is rejected or determined to be undesirable by IP activity analysis component 1032, a message rejecting the bid request and associated inventory may be transmitted to the SSP from which the bid request came without having to further analyze the information within the bid request, saving valuable time.

Bot detection component 1030 may further comprise consumer device monitoring component 1034. In one embodiment, consumer device monitoring component 1034 may determine whether the client device that generated the bid request (by visiting a webpage) is connected to a monitor or whether light on the monitor of the client device has been detected. In some instances, information regarding whether a monitor is connected to the client device may be contained in the bid request. In such cases, this information can be quickly evaluated. In other cases, other information within the bid request may be cross-referenced or compared against data associated with past transactions in order to determine if the IP address or web browser associated with the bid request has ever been determined to lack a connected monitor. For example, in some embodiments, it may not be possible to determine whether a monitor is connected to the client device until after inventory has been purchased at the IP address or web browser. Once inventory has been purchased, the exchange and/or a DSP or advertiser may have an open communication channel to transmit and receive further information regarding the client device. Thus, details such as whether a monitor is connected to the client device may sometimes be “learned” using a trial-and-error process in conjunction with a database for storing information associated with past bid/ad requests and purchases. Regardless of when or how the absence of a monitor may be detected, once such a determination is made, it may be presumed that a bot is generating the web traffic and the bid request rather than a live person. Bid requests associated with the corresponding client device may then be filtered out of the exchange rather than sold to unsuspecting DSPs or advertisers.

In some embodiments, where the consumer device monitoring component 1034 determines that the bid request may be associated with undesirable inventory, a message rejecting the bid request and associated inventory may be transmitted to the SSP from which the bid request came without having to further analyze the information within the bid request, saving valuable time.

Filtering component 1000 may also comprise iFrame breaker component 1050. As depicted in FIG. 10, iFrame breaker component 1050 may comprise an iFrame detection component 1052 and an iteration component 1054. In one aspect, once inventory has been purchased from a publisher or SSP, the purchaser (e.g., the exchange, a DSP, or a marketer) may gain additional access and details regarding the webpage in which the inventory is positioned. This can be accomplished by transmitting a link to code (as part or separate from an advertisement) that the publisher may use to insert content at the location of the inventory. The code, once placed at the location of the inventory, can then detect and transmit information about its location back to the purchaser of the inventory. Among the information that the code may detect and/or transmit back to the purchaser may be information indicating that the advertisement is positioned within an Inline Frame (an “iFrame”). Generally speaking, an iFrame is an HTML document embedded inside another HTML document on a website. iFrames are commonly used to insert content from another source (such as an advertisement) into a webpage. The iFrame may behave like an inline image in many respects, but it may also be configured with its own scrollbar, etc. Additionally, the presence of an iFrame may obscure or otherwise prevent a purchaser of inventory from learning the true identity/nature of the underlying webpage in which the iFrame is located. In fact, some malicious publishers use iFrame “stacks,” i.e., several layers of iFrames positioned within iFrames, in order to disguise the true nature of the underlying webpage. Thus, a purchaser's desire to buy only “clean” inventory meeting particular standards may be frustrated by publishers obscuring information pertaining to a webpage that would otherwise cause a buyer to refuse or pass on the inventory.

Once inventory has been purchased and the code or some other data transmission has been placed at the location of the inventory, not only can information indicating that the inventory is positioned within an iFrame be detected, but information pertaining to the parent HTML document (the document within which the iFrame is positioned) may also be identified, transmitted, and/or analyzed. The information pertaining to the parent HTML document may then be used to transmit code or another link to code from the purchaser to that parent HTML document. Iterative process component 1054 may then repeat the iFrame detection process in order to determine if the parent document is an iFrame and, if so, information identifying its parent HTML document. This process may repeat itself until a parent HTML document other than an iFrame is identified, thereby allowing the exchange or purchaser to assess the nature and content of the underlying webpage.

After the non-iFrame, parent HTML document may be identified and analyzed, information pertaining to the parent document may be stored in a database and associated with bid requests containing information indicative of any previously-identified iFrames within the parent document. In this manner, when a bid request associated with one of the previously-identified iFrames is transmitted to the exchange, information from the bid request may be cross-referenced against the database and the exchange can ascertain the true nature of the underlying webpage without needing to purchase the associated inventory and engage in the iterative process described above.

Thus, in embodiments where it may be determined by the iFrame breaker component 1050 that the bid request may be associated with undesirable inventory, a message rejecting the bid request and associated inventory may be transmitted to the SSP from which the bid request came without having to further analyze the information within the bid request, saving valuable time.

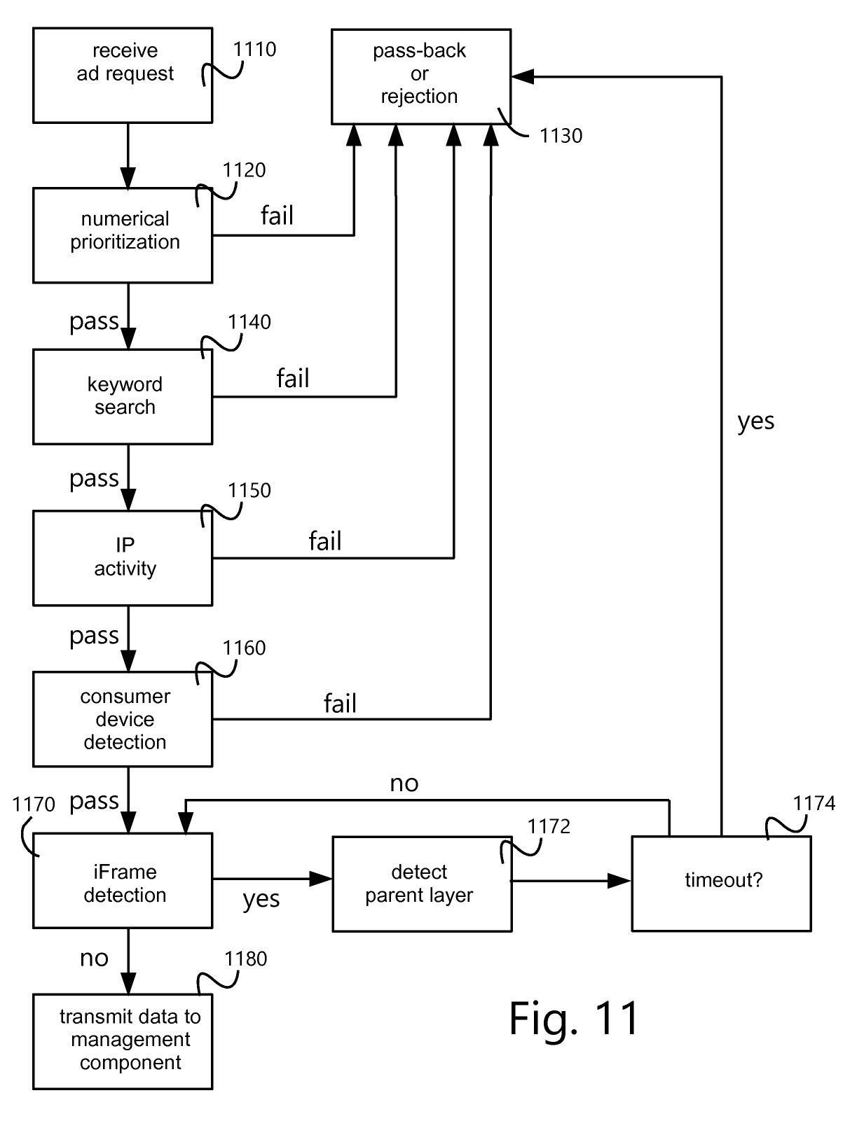

FIG. 11 depicts an exemplary embodiment of a method for filtering out bid/ad requests associated with undesirable inventory. At step 1110, the RTB exchange may receive a bid request from an SSP or directly from a web publisher that may or may not be hosting its own auction for the purchase of the inventory. The bid request may be substantially similar to the bid requests described previously herein, however, other types or forms of bid/ad requests and/or bid/ad requests comprising more, less, or different information may also be received at the exchange.

At step 1120, information associated with a bid request may be subjected to numerical prioritization. In other words, numerical information contained in the bid request may be analyzed or extracted from the ad request prior to any analysis or extraction of alphabetical information contained in the bid request. For example, information pertaining to an IP address and contained in the bid request would be represented numerically rather than alphabetically. Regardless of how information may be presented in the bid request, numerical data such as an IP address may be identified and analyzed quickly, prior to any other analysis of the bid request. For example, numerical data indicative of the client and/or webpage IP address may be cross-referenced against a database of known “bad” IP addresses. As described above, an IP address may be characterized as “bad” for a number of reasons, including but not limited to: past identification as a malicious site; past association with bot-like activity; and/or past identification as a website associated with restricted content. The ability to quickly and efficiently eliminate undesirable bid requests from the exchange may be critical, particularly considering the limited time within which the inventory and/or bid request must be transmitted, evaluated, placed up for auction, and/or sold.

In instances where a known bad IP address is identified, the exchange may transmit a pass-back or rejection message to the sender of the bid request at step 1130, informing the source of the request that the bid request has been rejected and/or will not be sold within the exchange. In some embodiments, the pass-back or rejection message may contain information describing the reason for the pass-back or rejection. For example, the pass-back or rejection message may contain a message such as “bad IP address” or “suspected bot.” In further embodiments, the pass-back or rejection message may trigger a monetary indemnification or payment from the source of the bid request to the exchange. This may be the case in instances where the SSP or publisher who generated and/or transmitted the bid request to the exchange has guaranteed the “clean” nature of its inventory or is otherwise contractually bound to provide only clean inventory. Where the source of the bid request is contractually bound to pay monetary penalties at each instance of providing bad inventory, the pass-back or rejection message from the exchange may serve to initiate such a payment.

Where the numerical data contained or associated with the bid request does not trigger a pass-back or rejection message, alphabetical data in the bid request may then be subjected to keyword analysis at step 1140. For example, alphabetical data contained or associated with the bid request may be searched for letters, words, and/or phrases indicative of malicious or undesirable content (e.g., “XXX,” “nude,” or “ad pumping”). In other embodiments, alphabetical information contained in the bid request may be cross-referenced against a database of known letters, character strings, words, or phrases that have previously been associated with malicious or undesirable web content. As described above, performing keyword searching on alphabetical information contained within the bid request quickly or early in the exchange's filtering process may save a considerable amount of time that would otherwise be spent processing or analyzing a bid request that should eventually be removed from the exchange.

In another aspect, bid requests found to be undesirable based, at least in part, on alphabetical data analysis may trigger a pass-back or rejection message at step 1130. The pass-back or rejection message may be substantially similar to the message described above with respect to the prioritized numerical analysis. In further embodiments, the pass-back or rejection message may contain information identifying one or more keywords contained in or associated with the bid request that led to the rejection.

In another aspect of the method depicted in FIG. 11, IP address activity associated with bid requests that have not been filtered out based on numerical and/or alphabetical data may be reviewed, interpreted, or otherwise analyzed at step 1150. For example, the bid request may contain cookies or other information indicative of online behavior exhibited at a client IP address or within a consumer's browser. In one embodiment, the number of webpages visited by a client device/browser within a predetermined period of time may be evaluated. In instances where the client device/browser has visited a number of websites over a predetermined threshold in a predetermined period of time, it may be presumed that the client/browser is actually operating under the control of a bot rather than a live person. In an alternative embodiment, rather than evaluating the number of websites an IP address or web browser has visited in a predetermined period of time, the number of advertisements viewed at the client/browser in a predetermined period of time may be reviewed, evaluated, or analyzed. In instances where a client/browser has displayed a number of advertisements over a predetermined threshold within a predetermined period of time, it may be presumed that the client/browser is operating under the control of a bot rather than a live person.

Bid requests associated with IP activity indicative of bot control may trigger a pass-back or rejection message at step 1130. The pass-back or rejection message may be substantially similar to the messages described above with respect to previous steps. In further embodiments, the pass-back or rejection message may contain information explaining the activity that triggered the rejection.

At step 1160, the exchange may determine whether the client device that generated the bid request is connected to a monitor or whether light on the monitor of the client device has been detected. As discussed above with respect to FIG. 10, information regarding whether a monitor is connected to the client device may be contained in the bid request or information associated with the bid request may be cross-referenced or compared with data associated with past transactions in order to determine if the IP address or web browser associated with the bid request has ever been determined to lack a connected monitor. Regardless of when or how the absence of a monitor may be detected, once such a determination is made, it may be presumed that the client device is under the control of a bot rather than a live person.

Bid requests associated with client devices likely under the control of a bot may then trigger a pass-back or rejection message at step 1130. The pass-back or rejection message may be substantially similar to the messages described above with respect to previous steps. In further embodiments, the pass-back or rejection message may contain information explaining the reason or justification for the rejection.

At step 1170, iFrame detection may then be performed with respect to bid requests that have not been filtered out of the exchange at any of steps 1110-60. As described above, once inventory has been purchased from a publisher or SSP by the exchange or another party, the purchaser may gain additional access and details regarding the webpage in which the inventory is positioned. This can be accomplished by transmitting a link to code (as part or separate from an advertisement) that the publisher will use to insert content at the location of the inventory. The code, once placed at the location of the inventory, can then detect and transmit information about its location back to the purchaser of the inventory. Among the information that the code may detect and/or transmit back to the purchaser may be information indicating that the advertisement is positioned within an iFrame.

Further, at step 1172, where a bid request is determined to be associated with inventory within an iFrame, information pertaining to the parent HTML document (the document within which the iFrame is positioned) may also be identified, transmitted, and/or analyzed.

Next, at step 1174, the exchange may determine whether there is sufficient time to continue reviewing the inventory associated with the bid request. As described above, the process of receiving, reviewing, filtering, and selling inventory associated with a bid request may need to be accomplished in as little as 150 ms. Of course, this time is exemplary only and may be less than or greater than 150 ms. Regardless, where a publisher has stacked multiple iFrames one within another, it may take time to perform the iterative process described with respect to FIG. 10 to ultimately identify the non-iFrame, parent HTML document. As a result, each time an iFrame is detected and its parent HTML document is identified, the exchange must determine if there is sufficient time to further analyze that parent HTML, determine whether it is an iFrame, and, if so, the identity of its parent HTML. Where the time that has lapsed from receipt of the bid request at the exchange exceeds a predetermined time threshold, a pass-back or rejection message may be triggered at step 1130. The pass-back or rejection message may be substantially similar to the messages described above with respect to previous steps. In further embodiments, the pass-back or rejection message may contain information explaining that the bid request “timed out” due to use of one or more iFrames.

Alternatively, where the time that has lapsed from receipt of the bid request at the exchange is less than a predetermined time threshold, information associated with the newly identified parent HTML document may be reviewed or otherwise analyzed at iFrame detection step 1170. In instances where the parent document is determined to be an iFrame, steps 1172 and 1174 may repeat. In a further aspect, steps 1170-1174 may repeat until either the transaction times out or a non-iFrame, parent HTML document is identified.

Where a non-iFrame, parent HTML document is identified within the predetermined time constraints and, after any further analysis and/or review of the parent document is performed, information associated with the bid request may then be transmitted to a data management component described above with respect to other figures.

Of course, the filtering process depicted in FIG. 11 is exemplary only and alternative embodiments may comprise fewer, additional, or alternative steps/processes. Moreover, though FIG. 11 depicts the various filtering steps being performed in a particular order, alternative embodiments may comprise substantially similar steps performed in a different order, simultaneously, and/or in an overlapping fashion.

### Waterfall Component

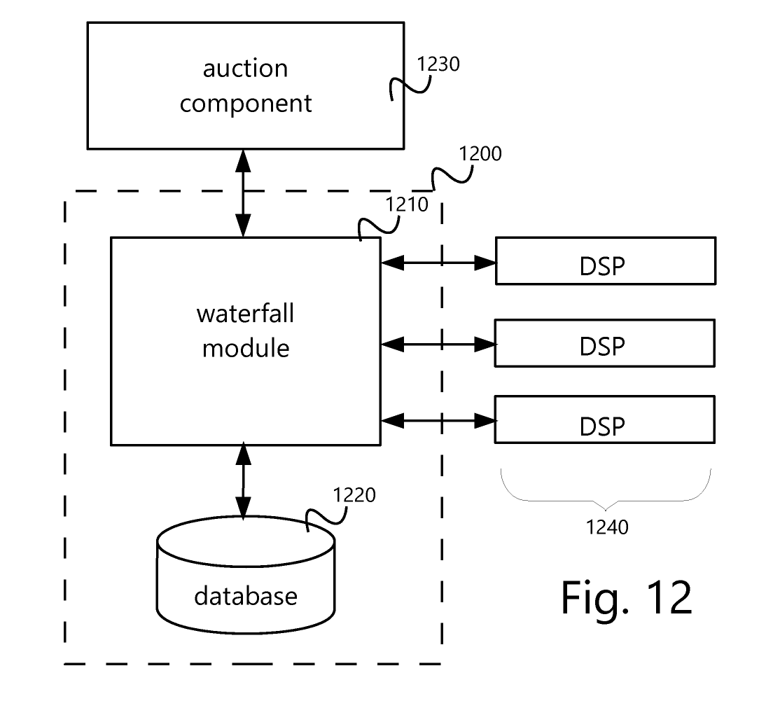

FIG. 12 depicts an exemplary embodiment of waterfall component 1200, which is substantially similar to waterfall component 660 of FIG. 6 and/or waterfall component 860 of FIG. 8. Waterfall component 1200 may comprise, in some embodiments, waterfall module 1210 and database 1220. As discussed above, where no bids are received on inventory from potential buyers (e.g., DSPs, advertisers, etc.) within an auction component 1230 or, alternatively, no satisfactory bids above a predetermined reserve price are received, the inventory may be passed to waterfall component 1200.

In one aspect, waterfall module 1210 may be associated or in communication with database 1220. Database 1220 may store information pertaining to past purchase and/or bidding behavior of one or more DSPs, SSPs, ad agencies, and advertisers. Moreover, database 1220 may contain information useful in determining the identity of the DSPs, SSPs, ad agencies, or advertisers 1240 believed to be the most desirable purchaser of the inventory, i.e., most likely to purchase the inventory at the highest price. In one embodiment, only the most desirable purchaser may be identified. In other embodiments, a prioritized list of the most desirable purchasers may be compiled or generated where the most desirable purchaser is identified within the list.

Once the most desirable potential buyer of the inventory is identified, waterfall component 1200 may generate an ad or bid request and transmit the ad request to the potential buyer. The ad request may be substantially similar to the ad request described above with respect to other embodiments, however, other types or forms of ad requests and/or ad requests comprising more, less, or different information may also be generated by waterfall component 1200. In one aspect, the ad request may comprise an offer price for the associated inventory rather than an invitation to submit a bid for the inventory in an exchange-hosted auction environment. Moreover, the offer price may be based, at least in part, on information contained and/or analyzed within database 1220. For example, the offer price may be associated with a price the recipient has paid in the past for similar inventory and/or under similar circumstances (e.g., in a similar geographic region, at a similar time of day, and/or the same day of the week).

Where the recipient of the ad request (i.e., the first waterfall recipient) decides to purchase the inventory at the offer price, the first waterfall recipient may transmit a confirmation message to waterfall component 1200 comprising a link to the advertisement desired to be displayed at the location of the inventory. In instances where the first waterfall recipient decides not to purchase the unsold inventory, a pass-back or rejection message may be transmitted to waterfall component 1200. In embodiments where a prioritized list of desirable buyers has been compiled or generated, waterfall component 1200 may then transmit the ad request or a second ad request to a second waterfall recipient of the remaining potential buyers, the second waterfall recipient now being the most likely to purchase the unsold inventory at the highest price. In embodiments where no such prioritized list has been compiled or generated, the information within the database may be further reviewed or analyzed to determine the most desirable purchaser in light of the first waterfall recipient's refusal to purchase the inventory. The process of transmitting ad requests, receiving a confirmation or pass-back/rejection message, and determining the next most desirable buyer may then repeat until a buyer of the unsold inventory is found and the offer price within an ad request is accepted.

It should be noted, in some embodiments, the offer price associated with each ad request is not necessarily the same despite the fact that the ad requests may be associated with the same inventory. For example, where database 1220 contains information indicating that buyer A has purchased inventory similar to inventory X at a price of $1.00 CPM (as used herein, “CPM” stands for “cost per impression” and is represented in terms of the cost of one thousand impressions) and buyer B has purchased inventory similar to inventory X at a price of $0.90 CPM, then an ad request containing an offer price of $1.00 CPM may first be transmitted to buyer A and, if buyer A declines to purchase the inventory, an ad request may then be transmitted to buyer B containing an offer price of $0.90 CPM. Of course, this example is only exemplary and any suitable process for determining an offer price within an ad request may be used.

Once a buyer of the unsold inventory is found and a link to the advertisement desired to be displayed is received at waterfall component 1200, waterfall component 1200 may transmit a link to the advertisement to be displayed and a bid for the inventory that is based, at least in part, on the price agreed to by the buyer of the inventory. In some embodiments, prior to transmitting the bid to the SSP-hosted auction, the predetermined price agreed to by the latest waterfall recipient may be adjusted or modified as described previously herein in order to increase win rates, volume and liquidity within the exchange.

Where the bid transmitted to the SSP-hosted auction is then selected as the winning bid, the SSP or publisher may then transmit a confirmation message back to the exchange. Alternatively, where the bid is not selected as the winning bid, the SSP or publisher may transmit a rejection or losing bid message to the exchange. The exchange may then generate and/or transmit a message to the buyer of the inventory indicative of a completed transaction or an unsuccessful bid.

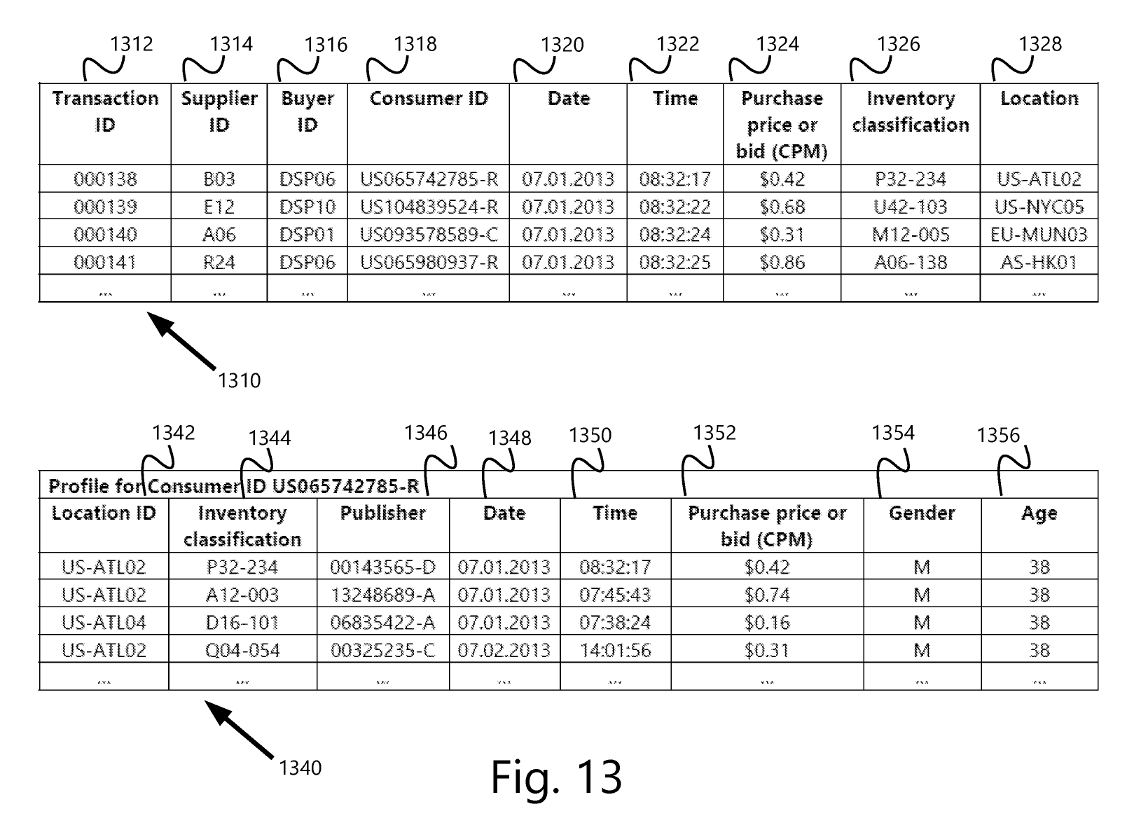

FIG. 13 depicts exemplary embodiments of data contained within database 1220. In one aspect, the database may contain one or more tables 1310, 1340 comprising data (e.g., records in each row of one or more tables) associated with past transactions. In one embodiment, the data may be compiled from past transactions in which the exchange played a role. In other embodiments, the data may be purchased from a third party that collected or otherwise possesses the data. In further embodiments, the data contained in database 1220 may be a combination of third party data and data collected from transactions involving the exchange.

In one embodiment, table 1310 may comprise one or more of a transaction identification number 1312, a supplier identification number 1314, a buyer identification number 1316, a consumer identification number 1318, a transaction date 1320, a transaction time 1322, a transaction purchase price and/or bid amount 1324, a transaction inventory classification code 1326, and a location code 1328. Table 1310 may also contain information regarding the display at which inventory is to be displayed, such as device, size, and/or formatting information. In other embodiments, table 1310 may contain additional information regarding the particular consumer that generated the initial bid/ad request (e.g., gender, age, past online purchase information, etc.). Table 1310 may also contain other information useful to the exchange when evaluating potential buyers of inventory and determining a most desirable buyer. The examples provided herein are only exemplary and should not be construed as exhaustive of the possibilities.

As shown in FIG. 13, information (e.g., records) contained in table 1310 may comprise a combination of one or more alphanumeric character strings, however, various suitable identifiers including one or more alphabetical characters or numerical characters may be used.

In another aspect, database 1220 may further comprise one or more records 1340 containing information associated with a particular consumer identification number. In one embodiment, table 1340 may comprise one or more of a location code 1342, an inventory classification code 1344, a publisher identification number 1346, a transaction date 1348, a transaction time 1350, a transaction purchase price or bid amount 1352, a gender identifier 1354, and an age identifier 1356. Record 1340 may contain alternative or additional information helpful to the exchange when evaluating potential buyers of inventory and determining a most desirable buyer. Again, the examples provided herein are only exemplary and should not be construed as exhaustive of the possibilities.

In another aspect, data contained in tables 1310, 1340 can be used by the exchange to determine the most desirable potential buyer of inventory. In some embodiments, the data may also be used to compile or generate a prioritized list of one or more potential buyers. Moreover, an offer price for the inventory transmitted to one or more potential buyers in the form of an ad or bid request may be based, at least in part, on the data (e.g., records) contained in tables 1310, 1340.

Thus, when inventory passed from an auction component is received by waterfall component 1200, the inventory may be assigned an inventory classification based on the webpage on which the inventory resides and a location identifier based on IP address location of the consumer's CPU or browser. These assignments can be made within waterfall component 1200 or at some time before or after inventory is received at waterfall component 1200. Additionally, the originating supplier and consumer, as well as a date and time associated with the original ad or bid request may be known and/or recorded. This information may then be cross-referenced against information contained in tables 1310 and/or 1340 in order to determine a most desirable buyer and/or compile a prioritized list of potential buyers.

For example, cross-referencing of tables 1310, 1340 may reveal that a buyer is particularly interested in purchasing inventory associated with one or more inventory classifications or inventory associated with a particular geographic location. Alternatively, cross-referencing of tables 1310, 1340 may reveal one or more buyers place relatively high bid amounts for inventory associated with a particular consumer or a consumer meeting certain demographic criteria. In other scenarios, it may be revealed that a buyer spends the bulk of its advertising dollars in particular time slots and in particular geographic regions. For instance, a buyer may pay relatively high CPMs for inventory between particular hours of the day for inventory associated with a particular geographic region, but pay relatively low CPMs for inventory at other times of the day or associated with other geographic regions. Such patterns may be revealed through a periodic analysis of data in the records.

In one embodiment, where the exchange compiles a prioritized list of buyers to contact for purchase of inventory, the records may be analyzed based on geographic region and every four hours in order to establish which buyer(s) to contact first with inventory passed through an auction component. Of course, such an embodiment is only exemplary and any other suitable algorithm for determining the most desirable purchaser of inventory may be used.

In FIG. 12, database 1220 is contained within waterfall component 1200 and the exchange may maintain and update its own records regarding past transaction data. For example, tables 1310, 1340 may be updated or supplemented with data collected from one or more components such as those depicted in FIGS. 4, 6 and 8 (e.g., a filtering component, a data management component, an auction component, and a viewability component). In other embodiments, however, database 1220 may be maintained and updated by a third party. In still further embodiments, the exchange may grant one or more DSPs or other potential buyers of inventory access to records 1310, 1340 to facilitate buyers' determinations as to whether to purchase specific inventory. Such access may be provided free of charge or buyers may pay for a subscription to database 1220.

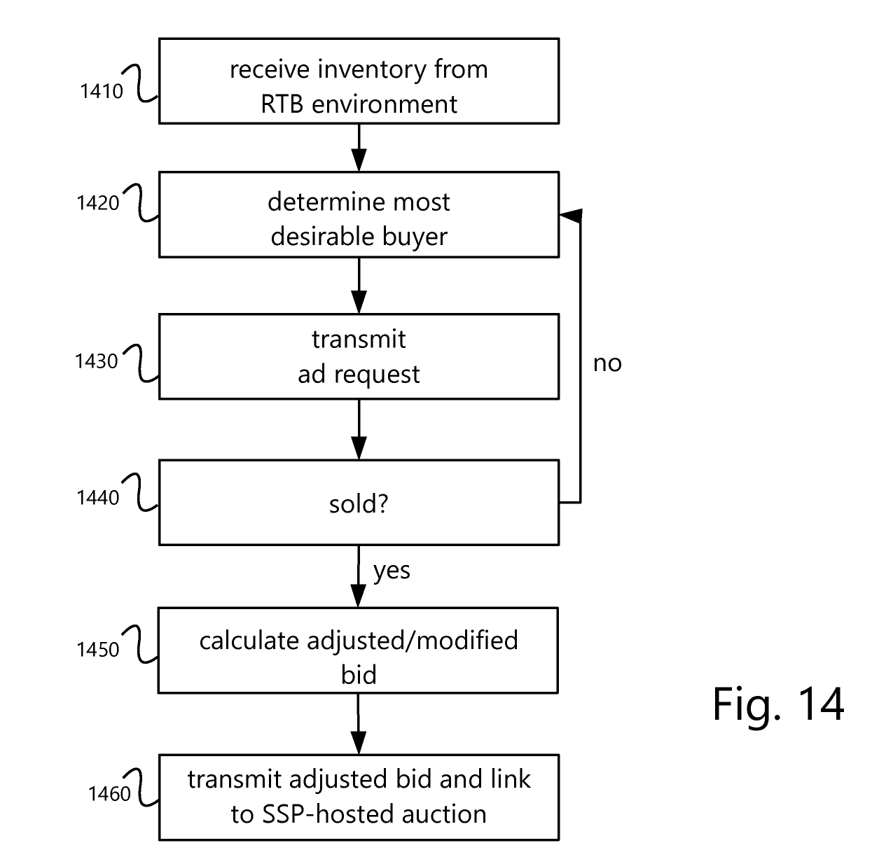

FIG. 14 depicts an exemplary embodiment of a method for selling inventory through a waterfall component. In one aspect, at step 1410, inventory that fails to receive a bid from potential buyers (e.g., DSPs, advertisers, etc.) within an auction component or, alternatively, receives no satisfactory bids above a predetermined reserve price, may be passed to a waterfall component such as waterfall component 1200 described above.

At step 1420, upon receipt of information pertaining to specific inventory, waterfall component 1200 may analyze data contained in database 1220 in order to determine the most desirable potential buyer of the inventory, i.e., the buyer most likely to purchase the inventory at the highest price. In other embodiments, data contained in database 1220 may be analyzed to compile a prioritized list of potential buyers. As previously discussed, database 1220 may contain various information pertaining to past transactions and past purchase behavior exhibited by buyers in communication with the exchange.

Once the most desirable potential buyer of the inventory is identified, an ad or bid request may be generated and transmitted to the potential buyer at step 1430. In one aspect, the ad request may comprise an offer price for the associated inventory. The offer price may be based, at least in part, on information contained and/or analyzed within database 1220. For example, the offer price may be based, at least in part, on price(s) the buyer has paid in the past for similar inventory and/or under similar circumstances (e.g., in a similar geographic region, at a similar time of day, and/or the same day of the week).

At step 1440, the recipient of the ad request (i.e., the first waterfall recipient) may decide to either purchase the inventory or reject the offer. Where the first waterfall recipient decides to purchase the inventory, the exchange may receive a confirmation message comprising a link to an advertisement desired to be displayed at the location of the inventory. On the other hand, where the first waterfall recipient rejects the inventory offer, the exchange may receive a pass-back or rejection message from the recipient.

In instances where the first waterfall recipient rejects the offer, the most desirable remaining buyer of the inventory may be determined at step 1420. Alternatively, at step 1420, where a prioritized list of potential buyers has been compiled, the identity of the next most desirable buyer, in light of the first recipient's rejection, may be determined. Steps 1420, 1430 and 1440 may then be repeated or looped until an ad/bid request is accepted by a buyer.

At step 1450, once a buyer of the unsold inventory is found and a link to the advertisement desired to be displayed is received at the exchange, the price for the inventory accepted by the most recent waterfall recipient may be modified or adjusted as described previously herein in order to increase win rates, volume and liquidity within the exchange.

Where an SSP or publisher is conducting its own auction for the inventory, the exchange may then transmit the link to the advertisement and the modified bid for the inventory to the SSP-hosted auction. If the bid is selected as the winning bid, the SSP or publisher may then transmit a confirmation message back to the exchange. Where the bid is not selected as the winning bid, the SSP or publisher may transmit a rejection or losing bid message to the exchange. The exchange may then generate and/or transmit a message to the buyer of the inventory indicative of a completed transaction or an unsuccessful bid.

Other embodiments will be apparent to those skilled in the art from consideration of the specification and practice of this disclosure. It is intended that the specification and examples be considered as exemplary only, with a true scope and spirit of the invention being indicated by the following claims.

What is claimed is:

1. A non-transitory, computer-readable medium containing instructions that, when executed by a processor, cause the processor to perform a method including:
receiving a request from a sender, the request being associated with an advertising space located within content being delivered over the Internet to a consumer;
extracting information from the request;
cross-referencing a database based, at least in part, on the information, the database comprising data pertaining to past transactions involving the sale of online inventory;
generating a prioritized list of one or more potential purchasers of the advertising space based, at least in part, on the data pertaining to the past transactions;
transmitting a first ad request to a first recipient on the prioritized list, the first ad request being associated with the advertising space and comprising a first offer price; and
if the first ad request is accepted by the first recipient, transmitting an acceptance message to the sender; or
if the first ad request is rejected by the first recipient, transmitting a second ad request to a second recipient on the prioritized list, the second ad request being associated with the advertising space and comprising a second offer price.

2. The non-transitory, computer-readable medium of claim 1, wherein the first offer price and the second offer price are the same.

3. The non-transitory, computer-readable medium of claim 1, wherein the first offer price and the second offer price are different.

4. The non-transitory, computer-readable medium of claim 1, wherein the first offer price and the second offer price are based, at least in part, on the data pertaining to the past transactions.

5. The non-transitory, computer-readable medium of claim 1, further comprising:
in response to receiving the request from the sender, hosting a real-time auction for the advertising space, wherein the processor performs at least the following:
solicit bids for the advertising space from one or more entities;
receive one or more bids from the entities; and
determine that the highest received bid is unsatisfactory; and
in response to receiving no satisfactory bids, generating the prioritized list of one or more potential purchasers of the advertising space.

6. The non-transitory, computer-readable medium of claim 1, wherein the data pertaining to the past transactions comprises data indicative of the past purchase and bidding behavior of the one or more potential purchasers of the advertising space.

7. The non-transitory, computer-readable medium of claim 6, wherein the data pertaining to the past transactions comprises categories of information including one or more of: an inventory classification identifier; a location identifier; a supplier identification; a consumer identification; and a date/time identifier.

8. The non-transitory, computer-readable medium of claim 7, wherein the data pertaining to the past transactions further comprises a consumer specific record comprising at least one of: demographic information pertaining to the consumer; and a history of inventory purchase prices associated with advertisements served to the consumer.

9. A system for selling advertising inventory in conjunction with a waterfall environment, the system comprising:
a filtering component configured to receive a bid request associated with an advertising inventory being sold within a real-time auction; and
a waterfall component configured to:
(a) generate a list of one or more potential purchasers of the advertising inventory;
(b) determine a recipient of an ad request associated with the advertising inventory, the recipient being the most desirable potential purchaser of the advertising inventory from the list;
(c) transmit an ad request to the recipient, the ad request comprising an offer price;
(d) if the ad request is not accepted by the recipient, remove the recipient from the list and repeat steps (b) and (c);
(e) if the ad request is accepted by the recipient, generate a bid based, at least in part, on the accepted offer price; and
(f) transmit the bid to the real-time auction.

10. The system of claim 9, wherein the waterfall component is further configured to access a database comprising information indicative of past purchase behavior of the one or more potential purchasers.

11. The system of claim 10, wherein the bid request comprises information used to cross-reference the database.

12. The system of claim 10, wherein the offer price associated with the ad request transmitted to each recipient differs for one or more respective recipients and is based, at least in part, on information contained within the database.

13. The system of claim 10, wherein the waterfall component is further configured to identify a time of day associated with the bid request and information contained in the database is categorized into one of a plurality of time of day ranges.

14. The system of claim 13, wherein the list of one or more potential purchasers of the advertising inventory is generated based, at least in part, on information associated with the time of day range encompassing the time of day associated with the bid request.

15. The system of claim 14, wherein the time of day ranges are four-hour increments.

16. The system of claim 9, wherein information associated with the bid request is evaluated within the filtering component prior to the waterfall component compiling a list of potential purchasers of the advertising inventory.

17. A computer-implemented method for selling advertising inventory in a real-time bidding environment, the method comprising:
(a) receiving a bid request associated with online inventory being sold in a real-time auction;
(b) in response to the bid request, accessing a database comprising information associated with past transactions;
(c) identifying a potential buyer of the online inventory based, at least in part, on the information contained in the database;
(d) determining an offer price based, at least in part, on the information contained in the database;
(e) transmitting an ad request to the potential buyer, the ad request comprising the offer price;
(f) if the ad request is not accepted:
(f)(1) identifying a next potential buyer of the online inventory based, at least in part, on the information contained in the database; and
(f)(2) repeating steps (d), (e), and (f)(1) until the respective ad request is accepted; and
(g) if the ad request is accepted, transmitting a bid amount to the real-time auction.

18. The computer-implemented method of claim 17, further comprising increasing or decreasing the accepted offer price in accordance with a predetermined algorithm to generate the bid amount prior to transmitting the bid amount to the real-time auction.

19. The computer-implemented method of claim 17, further comprising granting access to the database to any recipient of the respective ad request.

20. The computer-implemented method of claim 17, wherein the access granted to any recipient of the respective ad request is limited to cross-referencing the database using information contained in the ad request.
